(19) United States
(12) Patent Application Publication
(10) Pub. No.: US 2026/0200084 A1
(43) Pub. Date: Jul. 16, 2026

(54) CONTROLLER AND COMPUTER

(71) Applicant: FUNKU CORPORATION, Yamanashi (JP)

(72) Inventor: Yuuki KONDOU, Yamanashi (JP)

(21) Appl. No.: 19/127,981

(22) PCT Filed: Nov. 15, 2022
(86) PCT No.: PCT/JP2022/042393

§ 371 Date: May 7, 2025

(51) Int. Cl. B25J 9/16

(52) U.S. Cl. CPC B25J 9/1664

(57) ABSTRACT

A controller includes a processor and a storage unit storing an effector restriction, which is a restriction on a change in at least one of a position or an orientation of an effector of a robot as seen from predetermined reference coordinates, where the processor is configured to cause the robot to execute an operation restricted by the effector restriction, which is set based on an input by a user or from an external device.

### CROSS-REFERENCE TO RELATED APPLICATION(S)

This is a National Stage Entry into the United States Patent and Trademark Office from International Patent Application No. PCT/JP2022/042393, filed on Nov. 15, 2022, the entire contents of which are incorporated herein by reference.

### FIELD OF THE INVENTION

The present disclosure relates to a controller and a computer.

### BACKGROUND OF THE INVENTION

In the field of industrial robots, a user generally teaches a robot to make the robot execute a desired operation. A controller of the robot generates a route based on the teaching and moves the robot. In general, a mode in which the robot moves without an operation of the user based on an operation command which is set in advance is referred to as an automatic operation mode, an AUTO mode, and the like. Also, in general, when the user teaches the robot, the user performs an operation, which is called jog operation, using a portable operation board. During the jog operation, the user is required to observe the robot, an effector, an object including a workpiece, and the like carefully so that the robot moves safely. In addition, the user is also required to consider orientation of the effector so that the effector can perform its function.

When the route for the automatic operation mode is generated, cycle time is important in general. Further, there is a case in which a restriction such as only allowing rotation around an axis vertical to the ground and the like is set in the robot operation.

In the field of industrial robots, generally, there is a known function in which an operable area or a entrance-prohibited area is set in advance so that the robot does not interfere with its surroundings, and the robot moves only within a range in which the robot does not interfere with the surroundings. A function of performing detailed interface calculation using 3D models of a robot and the surroundings is also known. For example, please see Japanese Unexamined Patent Application, Publication No. 2017-094430.

In the field of industrial robots, a technique of generating a route so that a protruding portion of the effector does not face a person and the like is also known. For example, see Japanese Unexamined Patent Application, Publication No. 2016-196069.

### SUMMARY

A controller according to a first aspect of the present disclosure includes a processor; and a storage unit storing an effector restriction which is a restriction on a change in at least one of a position or an orientation of an effector of a robot as seen from predetermined reference coordinates, wherein the processor is configured to cause the robot to execute an operation restricted by the effector restriction which is set based on an input by a user or from an external device.

A controller according to a second aspect of the present disclosure includes a processor; a storage unit; and a display device which displays a setting screen of an effector restriction which is a restriction on a change of at least one of a position or an orientation of an effector of a robot as seen from predetermined reference coordinates, wherein the setting screen is for setting the effector restriction based at least on an input by a user.

A computer according to a third aspect of the present disclosure includes a processor; a storage unit; and a display device configured to display a setting screen of an effector restriction which is a restriction of a change on at least one of a position or an orientation of an effector of a robot as seen from predetermined reference coordinates, wherein the setting screen is for setting the effector restriction based at least on an input by a user, and the processor is configured to perform a simulation that causes a model of the robot to perform the operation by using at least the effector restriction, and determine whether or not the operation satisfies a criterion.

### BRIEF DESCRIPTION OF DRAWINGS

FIG. 1 is a schematic diagram of a robot system including a robot according to a first embodiment.

FIG. 2 is a block diagram showing a configuration of a controller of the robot according to the present embodiment.

FIG. 3 is a schematic diagram of various effectors attached to the robot according to the present embodiment.

FIG. 4 is a schematic diagram showing an operation of an effector attached to the robot according to the present embodiment.

FIG. 5 is an example of an effector restriction set in the controller of the present embodiment.

FIG. 6 is an example of a screen displayed by the controller of the present embodiment.

FIG. 7 is an example of a screen displayed by the controller of the present embodiment.

FIG. 8 is an example of a screen displayed by the controller of the present embodiment.

FIG. 9 is an example of a screen displayed by the controller of the present embodiment.

FIG. 10 is an example of a screen displayed by the controller of the present embodiment.

FIG. 11 is an example of a screen displayed by the controller of the present embodiment.

FIG. 12 is an example of a screen displayed by the controller of the present embodiment.

FIG. 13 is an example of a screen displayed by the controller of the present embodiment.

FIG. 14 is a block diagram showing an example of a function of a controller of the present embodiment.

FIG. 15 is an example of a screen displayed by the controller of the present embodiment.

FIG. 16 is an example of a screen displayed by the controller of the present embodiment.

FIG. 17 is an example of a screen displayed by the controller of the present embodiment.

FIG. 18 is an example of a screen displayed by the controller of the present embodiment.

FIG. 19 is an example of a screen displayed by the controller of the present embodiment.

FIG. 20 is an example of a screen displayed by the controller of the present embodiment.

FIG. 21 is an example of a screen displayed by the controller of the present embodiment.

FIG. 22 is an example of a screen displayed by the controller of the present embodiment.

FIG. 23 is an example of a screen displayed by the controller of the present embodiment.

### DESCRIPTION OF EMBODIMENT(S) OF THE INVENTION

As an example, when there is an appropriate range of orientation, a position, and the like of an effector so that the effector can safely perform its function, it is desirable that the route of the robot satisfies this range. As an example, if the route generation or the jog operation reflecting nature of the effector is not performed, there is a possibility of causing an undesirable situation such as dropping an object such as a workpiece and the like. As an example, there are a wide variety of effectors attached to the distal end portion and the like of the robot, such as a hand or a suction cup for object handling, a torch for welding, a scanner for inspection, and the like, and it is desirable that the robot operates in accordance with the effector. As an example, a setting in which the orientation of the effector is fixed to a specific state narrows options of the route generation and jog operation, which is inefficient and may reduce the cycle time. A technique capable of conducting the setting according to the type of the effector, the function required for the effector, the type of the object, the type of the work, the function required for the work, and the like is desired.

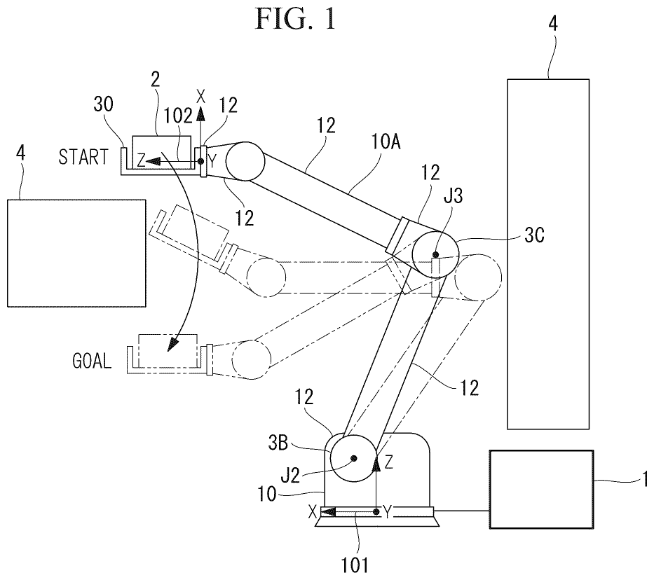

A controller 1 of a robot according to a first embodiment will be described below. The controller 1 is provided so as to control an arm 10A of a robot 10 (see FIG. 1).

Although the robot 10 is not limited to a specific type, the robot 10 of the present embodiment is an articulated robot having six axes. The robot 10 may be an articulated robot having five or less axes or seven or more axes, a horizontal articulated robot, a multi-link robot, and the like. Also, the robot 10 or its arm 10A may be supported by a travelling device such as a linear guide and the like, an AVG (Automatic Guided Vehicle), a vehicle, a walking type robot, and the like.

Also, the robot 10 may be a cooperative robot that can avoid contact, proximity, or the like with a person, an object, and the like existing in the surrounding environment by using a known sensor such as a visual sensor, a force sensor, and the like.

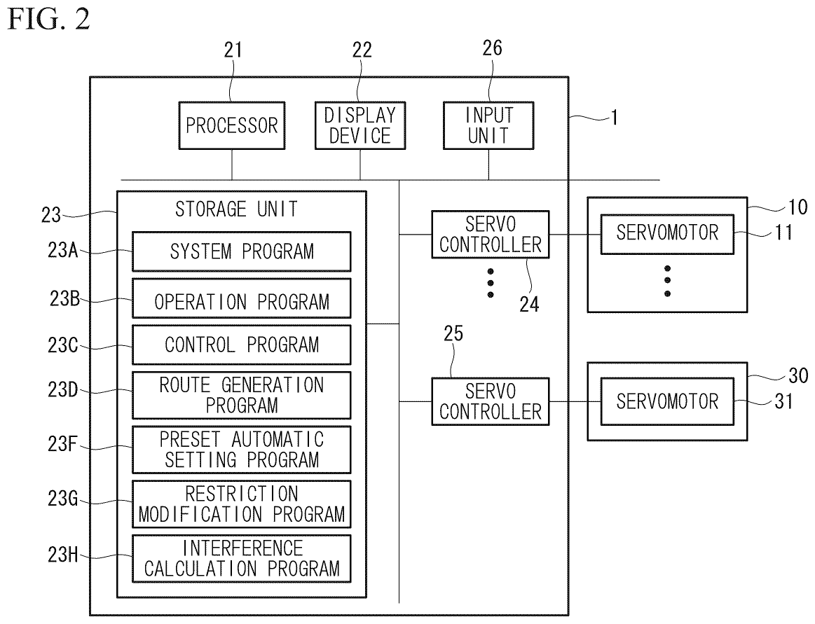

The arm 10A has a plurality of movable portions 12 that are connected to each other by using joints, and a plurality of servo motors 11 that respectively drive the plurality of movable portions 12 (FIGS. 1 and 2). Each servo motor 11 has an operation position detecting device such as a sensor, an encoder 11A, and the like for detecting its operating position. In the present embodiment, the controller 1 receives detection values of the encoder 11A.

As shown in FIG. 1, an effector 30 such as a hand, a tool, and the like is attached to a distal end portion of the arm 10A, for example, and the arm 10A is a part of a robot system that performs work on an object 2, which is a work target, on a conveying device, for example.

The work is a known work such as picking the object 2, processing for the object 2, attaching a component to the object 2, and the like. The processing for the object 2 is a known processing such as machining, painting, washing, and the like. The conveying device may be any device, such as a conveyer, an AGV (Automatic Guided Vehicle), or a vehicle under manufacturing, and the like, which can move the object 2. When the conveying device is a vehicle under manufacturing, a chassis, a tire, a motor, and the like functions as the conveying device, the object 2, which is a body and the like on the chassis, is conveyed. The object 2 may be a variety of objects, such as an object including an industrial product, food, and the like, a part of an object, a part of a structure, an animal, a part of an animal, a part of a person, and the like.

The effector 30 may be a dedicated hand, a suction cup, and the like for object handling. Also, the effector 30 may also include a wide variety of equipment such as a tool for assembly processes, a gun for spot welding, a torch for arc welding, a scanner for inspection system, and the like. In this manner, the effector 30 is not limited to a particular effector.

When the effector 30 has an operating portion such as a finger and the like of the hand, the effector 30 is provided with a servo motor 31 for driving the operated portion (see FIG. 2). The servo motor 31 has an operating position detecting device for detecting its operating position, and one example of the operating position detecting device is an encoder. Detection values of the operating position detecting device are sent to the controller 1. As each of the servo motors 11 and 31, various types of servo motors such as a rotary motor, linear motor, and the like can be used.

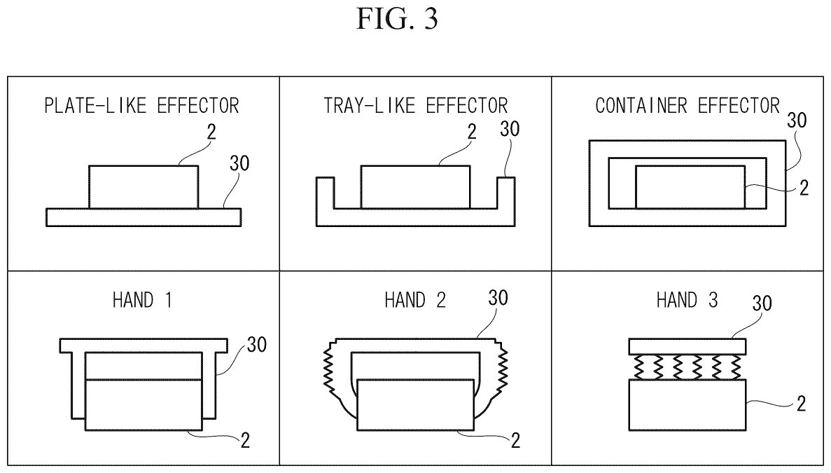

The effector 30 is mainly attached to the distal end portion of the arm 10A, however, the effector 30 may be attached to an intermediate portion or a base end portion of the arm A10 in the longitudinal direction. In a system in which the workpiece is transferred between the robot 10 and a person, a hand for gripping the object 2 or a hand for sucking the object 2 by means of a suction cup, a magnet, an electromagnet, and the like is often used as the effector 30, as shown in FIG. 3. Instead of this, there is a case in which the object 2 is placed in a container or on a flat plate like tray as the effector 30. Further, there is also a case in which the object 2 is placed in a box or a basket as the effector 30.

In recent years, a hand and the like that uses a finger having flexibility to softly grip an object has been widely used, and this hand is also an example of the effector 30.

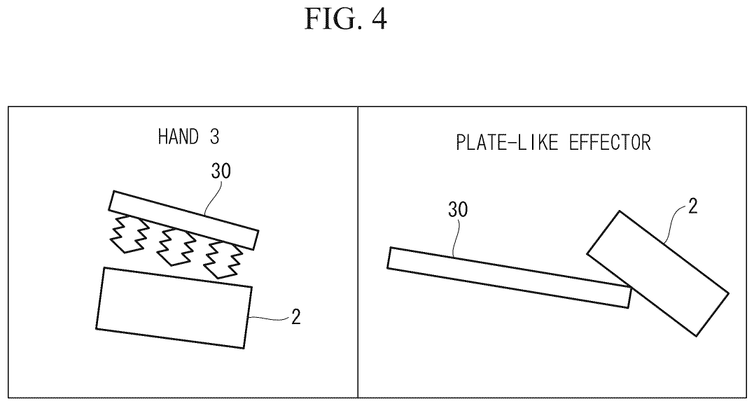

The above described effector 30 may have a limited orientation suitable for functioning as the effector. As shown in FIG. 4, if the effector 30, which is the hand using a suction cup, a magnet, or an electromagnet, for example, does not suck the object 2 from a predetermined direction such as an upward direction, the effector 30 may not hold the object 2 reliably. Moreover, in such a case in which the object 2 is placed on the effector 30, which is for example a tray, the user is expected to pay attention so that the object 2 does not fall from the tray.

As shown in FIG. 2, the controller 1 includes a processor 21 having one or a plurality of processor elements such as a CPU, a microcomputer, an image processing processor and the like, and a display device 22. Also, the controller 1 includes a storage unit 23 having a non-volatile storage, a ROM, a RAM, and the like.

Also, the controller 1 includes servo controllers 24 corresponding to the servo motors 11 of the robot 10, respectively, and a servo controller 25 corresponding to the servo motor 31 of the effector 30. The controller 1 also includes an input unit 26 connected to the controller 1 by wire or wireless. In an example, the input unit 26 is an input device such as a portable operation panel that can be carried by the user. In another example, the input unit 26 is a tablet computer. In such a case in which the input unit 26 is a portable operation panel, a tablet computer, and the like, the input is made by using a touch screen function. There is also a case in which the portable operation panel or the tablet computer has the display device 22.

The storage unit 23 stores a system program 23A, and the system program 23A plays a basic function of the controller 1. Also, the storage unit 23 stores a single or two or more operation programs 23B. The operation program 23B includes a plurality of commands, information, and the like for operating the robot. The operation program 23B of the present embodiment includes at least information regarding a coordinates and orientation at a plurality of teaching points, a command relating to movement between the teaching points, and the like.

The storage unit 23 also stores a control program 23C, a route generation program 23D, and the like. The control program 23C is a known feedback program, feedforward program, and the like.

The controller 1 generates a route based on the operation program 23B using the route generation program 23D, and generates a control command so as to move along the route using the control program 23C to control the arm 10A.

Also, when teaching a position and orientation of the arm 10A of the robot 10, it is normal to designate, as the teaching point and the like, coordinates seen from a reference coordinate system 101 (see FIG. 1) of the robot, which serves as a reference that does not move with respect to the space. In a state in which the effector 30 is not provided, the position and orientation of the coordinate system set on a flange surface (a mechanical interface) at the distal end of the arm 10A are normally designated as the teaching point and the like. In a state in which the effector 30 is provided, an effector coordinate system 102 (see FIG. 1) may be set at a predetermined position and the like of the effector 30. In this case, it is normal that the position and orientation of the effector coordinate system 102 are designated as the teaching point and the like.

Note that, in this embodiment, a coordinate system set at the distal end portion of the arm 10A is considered as the effector coordinate system 102, and a coordinate system set on the flange surface is also treated as the effector coordinate system 102.

In the present embodiment, the reference coordinate system 101 and the effector coordinate system 102 that does not move relative to the effector 30 are set. The effector coordinate system 102 may be called with another name, such as a tool coordinate system. The controller 1 recognizes the position and orientation of the effector coordinate system 102 in the reference coordinate system 101 by a well-known calibration and the like.

In this embodiment, the user can set an effector restriction that restricts relative change of the effector coordinate system 102 with respect to the reference coordinate system 101.

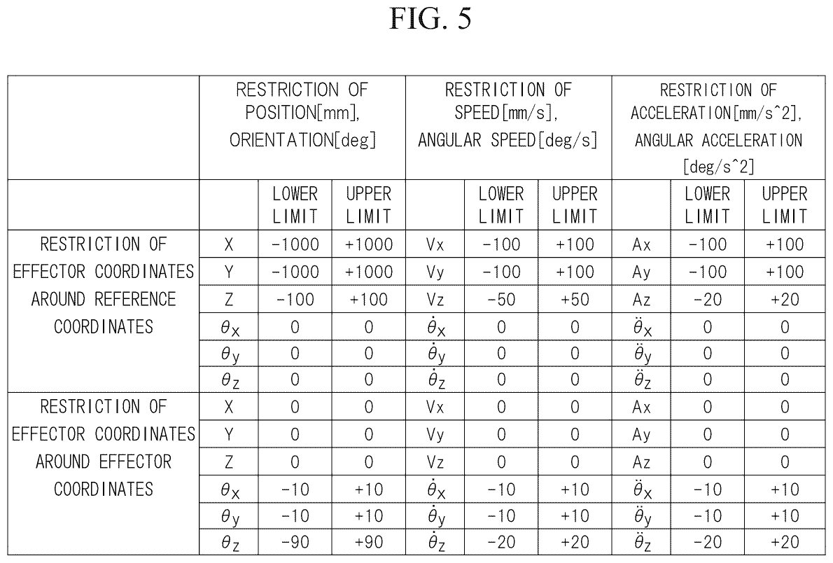

FIG. 5 shows a configuration example of the effector restriction. As shown in FIG. 5, a first example of the effector restriction is a restriction on the position coordinates (X, Y, Z) of the effector coordinate system 102. A second example of the effector restriction is a restriction on the orientation of the effector coordinate system 102 (around X axis=θx, around Y axis=θy, around Z axis=θz). Moreover, in the example of FIG. 5, a portion, in which “0” is entered in both the upper limit and the lower limit, means that the change is not allowed. The fact that the effector restriction is not set may be expressed by using “-” and the like.

The restriction on the relative change of the effector coordinate system 102 of the first example may be set with reference to the position and orientation of the reference coordinate system 101, the effector coordinate system 102, or another coordinate system. Note that the reference coordinate system 101, the effector coordinate system 102, or the other coordinate system is a predetermined coordinate system, which may be referred simply to as the coordinate system in the following description. The restriction on the orientation of the effector coordinate system 102 of the second example may also be set with reference to the position and orientation of the coordinate system. Note that the position restriction and orientation restriction of the effector coordinate system 102 may be set with reference to the position and orientation of the effector coordinate system 102 at the time before the arm 10A starts a certain operation.

As shown in FIG. 5, a third example of the effector restriction is a restriction on speed of the effector coordinate system 102. This speed is, for example, speed in a traveling direction of the effector coordinate system 102 in the coordinate system, or speed in each of X, Y, and Z directions. A forth example of the effector restriction is a restriction on angular speed of the effector coordinate system 102. This angular speed is angular speed of the effector coordinate system 102 around a certain axis line in the coordinate system, or angular speeds around the X, Y, and Z axes.

As shown in FIG. 5, a fifth example of the effector restriction is a restriction on acceleration of the effector coordinate system 102. This acceleration, for example, is acceleration in a traveling direction of the effector coordinate system 102 in the coordinate system or acceleration in each of the X, Y, and Z directions. A sixth example of the effector restriction is a restriction on angular acceleration of the effector coordinate system 102. This angular acceleration is angular acceleration of the effector coordinate system 102 around a certain axis line in the coordinate system, or angular acceleration around the X, Y, and Z axes. The effector restrictions in the third to sixth examples restrict the changes in at least one of the position and the orientation of the effector 30.

The effector restriction may be a combination of two or more of the first to sixth examples. In addition, it is possible to use a value, which is corresponding to an amount obtained by time-differentiating the position and/or the orientation three or more times, a formula, and the like. Also, the effector restriction may be a restriction of a change in the position and/or the orientation of the effector coordinate system 102 with respect to predetermined reference coordinates. Also, the change in the position and/or the orientation of the effector coordinate system 102 with respect to the predetermined reference coordinates is a change in the position and/or the orientation of the effector with respect to the predetermined coordinate system. Further the restrictions of the angular speed, the angular acceleration, and the like in the third to sixth examples are the restrictions of the changes in the position and/or the orientation of the effector as seen from the predetermined reference coordinates.

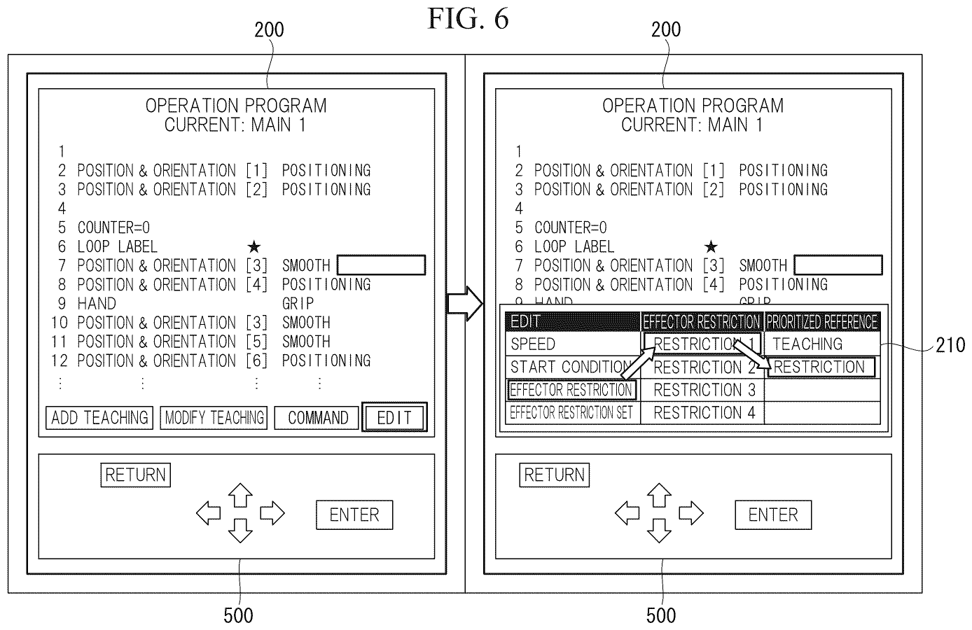

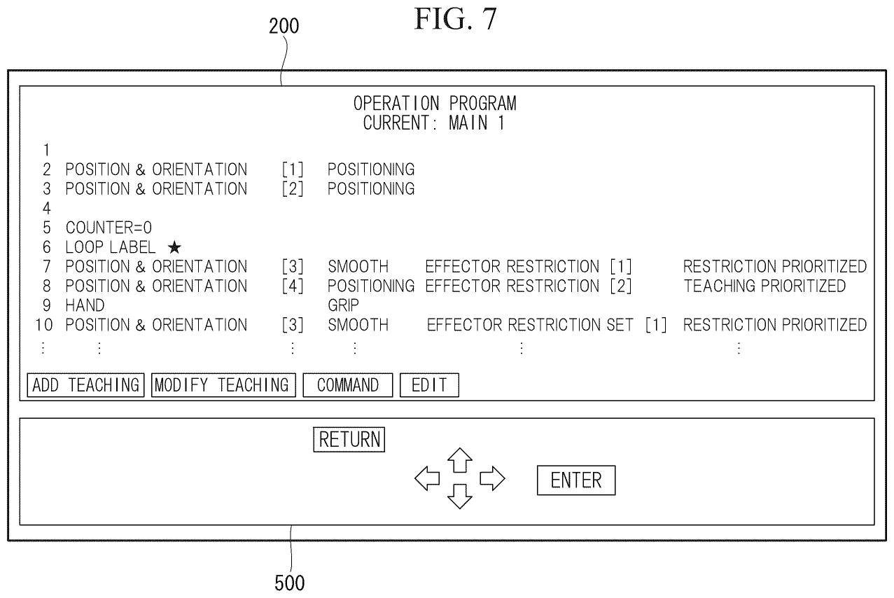

In a typical example of the present embodiment, the information on the coordinates and orientation, the command, and the effector restriction are set for each teaching point in the operation program 23B. In the screen 200 of FIG. 7 displayed on the display device 22 by the processor 21 of the controller 1, the effector restriction is not set for a teaching point 1 (position and orientation [1]) and a teaching point 2 (position and orientation [2]). On the other hand, the effector restrictions 1 and 2 will be set for each of a teaching point 3 (position and orientation [3]) and a teaching point 4 (position and orientation [4]), which will be described later. Preferably, the screen 200 of FIG. 6 is a screen for accepting an operation for displaying a screen related to the setting of the effector restriction. This operation is tapping a predetermined position on the screen 200 or tapping a predetermined button. The button may be provided in the input unit 26.

For example, when the user taps an area at the right of “smooth” of the teaching point 3 on the screen 200, an effector restriction setting screen 210 shown in FIG. 6 will appear. An effector restriction or an effector restriction set, which will be described later, can be selected on the setting screen 210. When this operation is performed repeatedly, the effector restriction or the effector restriction set is set at an arbitrary teaching point as shown in FIG. 7.

In one example, the user can set a coordinate system and restrictions regarding changes in the position and orientation of the effector coordinate system 102 with respect to the reference coordinates as the effector restriction. Preferably, the input unit 26 with which the user can modify the settings is provided on a portable operation panel, which is also referred to as a teach pendant. The setting of the effector restriction and the like are stored in the storage unit 23 or a predetermined storage unit such as a storage device of a separate controller, a storage unit on the cloud, and the like. When the effector restriction is stored in the storage device of the separate controller, the storage unit on the cloud, and the like, these storage device and storage unit function as a storage unit of the controller 1.

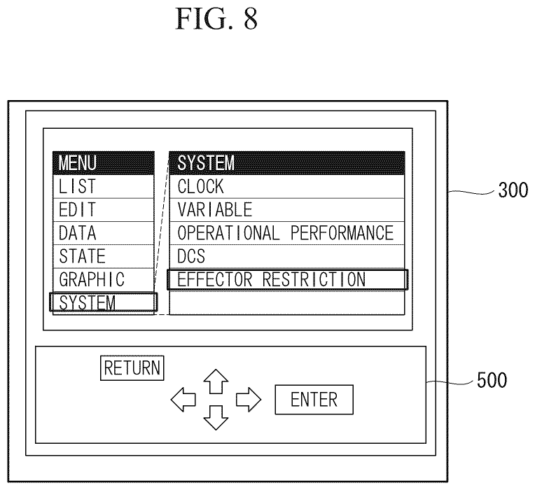

For setting the effector restriction, for example, a screen related to the settings is displayed on the display device 22 of the input unit 26. For example, the processor 21 of the controller 1 causes the display device 22 to display a screen 300 shown in FIG. 8. The screen 300 is a screen for the user to select moving to the effector restriction setting screen.

An operation portion 500 for performing the above mentioned selection and the like is displayed on the display device 22. A direction key, a determination key, a return key for returning to a screen before transition or an upper layer screen, and the like are displayed on the operation portion 500, and the user executes input by using those key operations. Note that a button corresponding to the function may be provided in the input unit 26.

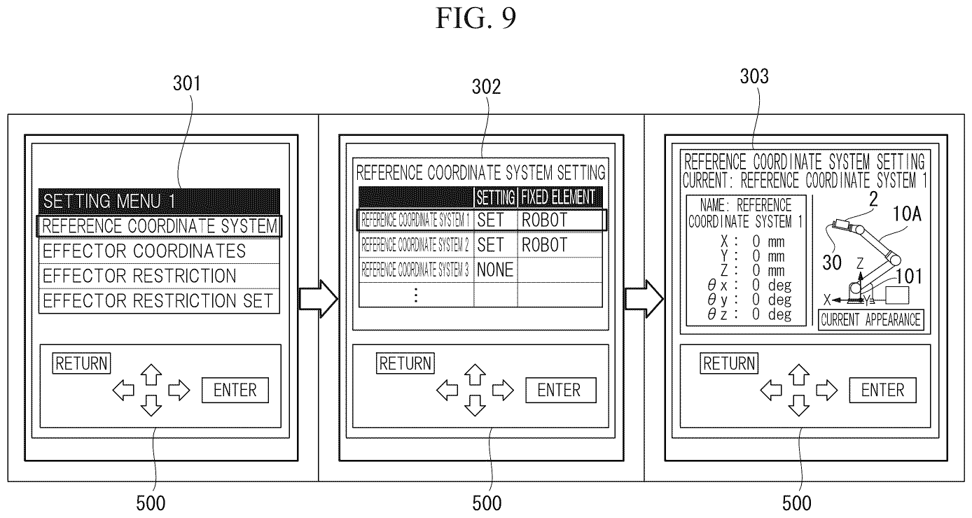

When the user selects moving to the effector restriction setting screen on the screen 300, the processor 21 causes the display device 22 to display a screen 301 of the FIG. 9. The screen 301 is a screen for the user to select moving to the reference coordinate system setting screen.

When the user select moving to the reference coordinate system setting screen on the screen 301, the processor 21 causes the display device 22 to display a screen 302 of FIG. 9. The screen 302 is a screen for the user to select the setting of an arbitrary reference coordinate system among the plurality of reference coordinate systems.

When the user selects a reference coordinate system 1 among the plurality of reference coordinate systems on the screen 302, for example, the processor 21 causes the display device 22 to display a screen 303 of FIG. 9. The screen 303 is a screen for setting the reference coordinate system 1 selected by the user. As shown in the screen 300, the user can set the positon and the orientation of the reference coordinate system 1.

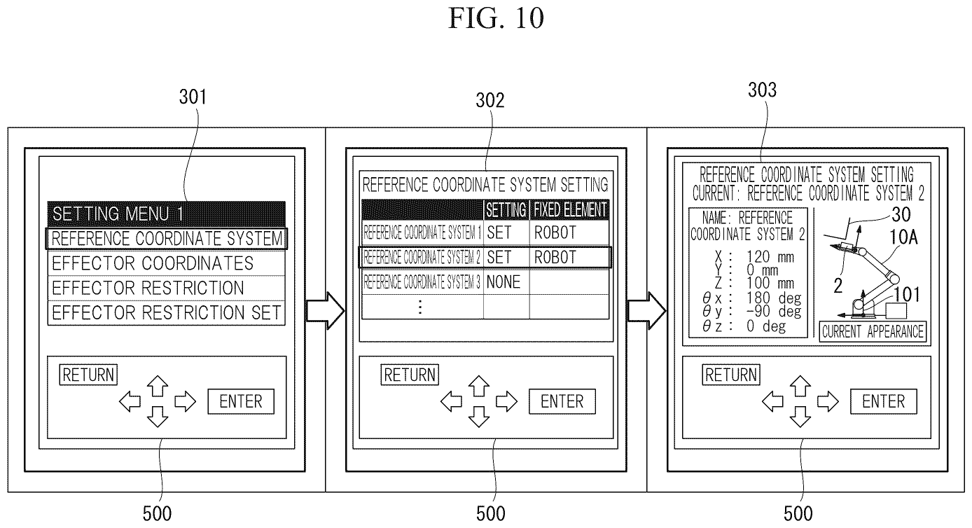

Further, when the user selects a reference coordinate system 2 on the screen 302, the processor 21 causes the display device 22 to display the screen 303 of FIG. 10. In FIG. 10, the user can set the selected reference coordinate system 2. The coordinate systems respectively set by the reference coordinate systems 1 and 2 and the like can be used as a reference coordinate system 101.

In the present embodiment, the user can set a plurality of reference coordinate systems by using the screen 302 and 303. This configuration is useful in improving flexibility of the effector restriction setting, which will be described later.

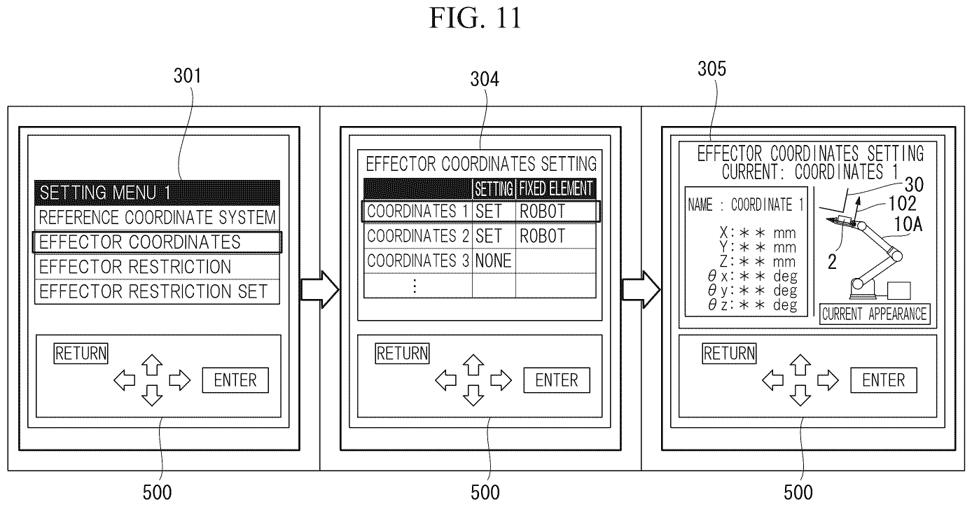

As shown in FIG. 11, when the user selects moving to the effector coordinates setting screen in a state where the display is returned to the screen 301, the processor 21 causes the display device 22 to display a screen 304 of FIG. 11. The screen 304 is a screen for the user to select a setting of effector coordinates among a plurality of effector coordinates.

When the user selects effector coordinates 1 among the plurality of effector coordinates on the screen 304, for example, the processor 21 makes the display device 22 display the screen 305 of FIG. 11. The screen 305 is a screen for setting the effector coordinates 1 selected by the user. As shown in the screen 305, the user can set the position and orientation regarding the effector coordinates 1.

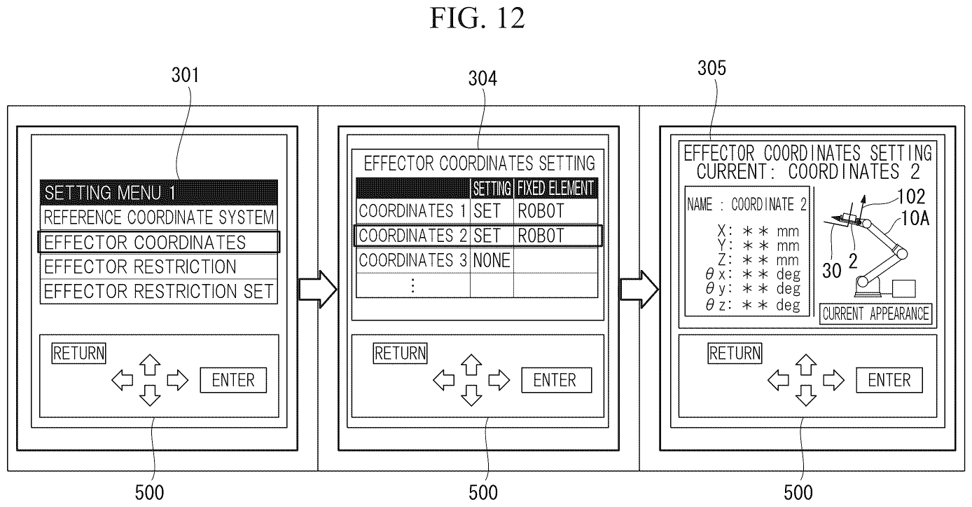

Moreover, when the user selects effector coordinates 2 on the screen 304, the processor 21 causes the display device 22 to display a screen 305 of FIG. 12. In FIG. 12, the user can set the selected effector coordinates 2.

In the present embodiment, the user can set the plurality of effector coordinates by using the screens 304 and 305. This configuration is useful for improving the flexibility of the effector restriction setting, which will be described later.

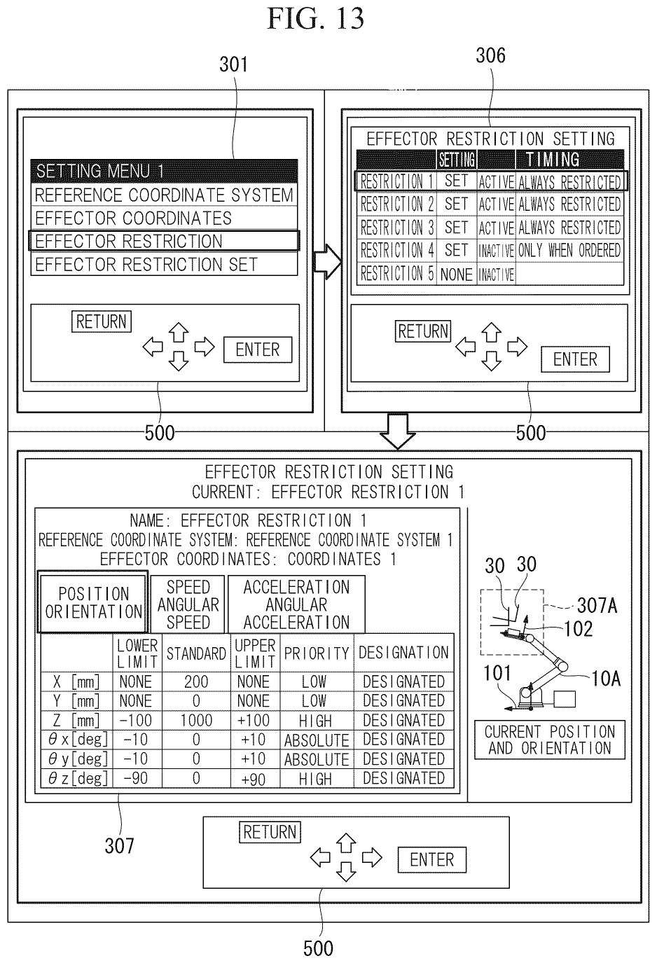

As shown in FIG. 13, when the user selects moving to the effector restriction setting screen in the state where the display is returned to the screen 301, the processor 21 causes the display device 22 to display a screen 306 of FIG. 13. The screen 306 is a screen for the user to select the setting of an arbitrary effector restriction among the plurality of the effector restrictions.

When the user selects the effector restriction 1 among the plurality of effector restrictions on the screen 306, for example, the processor 21 causes the display device 22 to display a screen 307 of FIG. 13. The screen 307 is a screen for setting the effector restriction 1 selected by the user, and the user can set the effector restriction by using the screen 307. The effector restriction is for restricting a change as seen from predetermined reference coordinates of the effector coordinate system 102 fixed to the effector 30.

More specifically, as shown in the screen 307, the user can set the reference coordinate system serving as the reference of the effector restriction 1. The effector restriction 2 can also be set in the same or a similar manner. When the reference coordinate system is fixed at any time, when the reference coordinate system 101 is used, and the like, the setting of the reference coordinate system on the screen 307 can be omitted.

Moreover, as shown in screen 307, the user can set effector coordinates for each effector restriction. Effector coordinates 1 are set for the effector restriction 1 on the screen 307. Similarly, effector coordinates 2 are set for the effector restriction 2, for example. The effector restriction restricts the change in the position and/or orientation of the effector 30 as seen from the set effector coordinates (predetermined reference coordinates). Therefore, a configuration in which the effector coordinates can be set or selected as described above and a configuration in which the user can set the effector coordinates for each effector restriction lead to an improvement in the flexibility of the setting by the user. Also, an effector restriction element, which will be described later, is set for each effector restriction.

On the screen 305 of FIGS. 11 and 12, the position and orientation of the effector 30 of the set effector coordinates are illustrated as an image. In FIG. 11, the effector coordinates 1 are set at a position located obliquely upward with respect to the effector coordinate system 102, and in FIG. 12, the effector coordinates 2 are set at a different position in a horizontal direction with respect to the effector coordinate system 102.

In the example of the above described operation program 23B of the screen 200, the effector restriction 1 is set for the teaching point 3 (position and orientation [3]). The processor 21 operates the arm 10A so that the effector 30 moves based on the operation program 23B. In this case, at a position between the teaching point 2 (position and orientation [2]) and the teaching point 3 (position and orientation [3]), the change in the position and orientation of the effector coordinate system 102 as seen from the effector coordinates 1 (predetermined reference coordinate) are restricted by the effector restriction element set in the effect restriction 1. The processor 21 may apply the restriction between the teaching point 3 and a teaching point 4. Similarly, with respect to the teaching point 4, the change in the position and orientation of the effector coordinate system 102 as seen from the effector coordinates 2 (predetermined reference coordinate) are restricted by the effector restriction element set in the effector restriction 2.

Here, the position of the effector coordinates 1 (predetermined reference coordinates) with respect to the effector 30 at the teaching point 3 corresponds to the position of the effector 30 at the effector coordinates 1 shown on the screen 305 of FIG. 11. The position of the effector coordinates 2 (predetermined reference coordinates) can also be set in a similar manner.

Moreover, there may be a case in which a teaching point and/or a passing point between the teaching points are used as the predetermined reference coordinates. That is, the change in the position and orientation at each teaching point and each passing point of the effector 30, which is moved by the operation program 23B, is controlled so as to be within the range of the effector restriction elements when seen from the position and orientation of the teaching point and the passing point.

In such a case in which the teaching point and/or the passing point between the teaching points are used as the predetermined reference coordinates, the settings of the screen 305 of FIGS. 11 and 12 will be unnecessary, and the setting of the effector coordinates of the screen 307 of FIG. 13 will also be unnecessary. The screen 307 of FIG. 13 may be configured so as to accept the setting to make the position and orientation of the teaching point or the passing point be the effector coordinates 1.

Also, it can be said that the effector restriction element of the effector restriction indicates a range in which the change in the position of the effector 30 is allowed. Typically, when the processor 21 operates the arm 10A in the above described configuration, an actual position and orientation of the effector 30 (effector coordinate system 102) are arranged within the range in which the change in the position of the effector 30 is allowed by the effector restriction.

Also, there may be a case in which the target of the effector restriction 1 is a section. In this case, for example, an item of “range of application of effector restriction” is indicated on the screen 307, and the user inputs a teaching point number and the like of the target of the effector restriction at the right of an indication of “range of effector restriction”. When the teaching point numbers are a plurality of consecutive numbers, the corresponding section will be the target of the effector restriction 1.

Also, the target section of the effector restriction may be specified by writing start/end in the operation program 23B for the start/end of the effector restriction.

An effector restriction that is always applied may be set regardless of the operation program 23B.

In addition, for each effector restriction, an operation program 23B for which the restriction is always applied may be set.

Moreover, on the screen 307 shown in FIG. 13, a space or an orientation type of the arm 10A may be set as “range in which effector restriction is applied”. For example, a range of a broken line 307A in FIG. 13 indicates a range in the X-Z direction, however, a range of about several tens of centimeter may be set in the Y direction in the range, for example. When the user inputs in the space at the right of the “range in which effector restriction is applied” by selecting the space on the screen 307, the space is set as the range in which the effector restriction 1 is applied. Similarly, a plurality of orientation types of the arm 10A may be shown on the screen 307, and a selected orientation type may be input at the right of the “range in which effector restriction is applied”. In this case, the effector restriction 1 is applied as long as the orientation of the arm 10A corresponds to the orientation type. Further, it is also possible to adopt a configuration in which the user can set a route subject to the effector restriction on the screen 307.

Also, based on the effector restriction set at each teaching point of the operation program 23B and another set effector restriction, the controller 1 can set the effector restriction automatically. Since this automatically set effector restriction is based also on the effector restriction set for each teaching point by the user, it is the effector restriction set based on the input of the user.

Also, there may be a case in which the user teaches, to the controller 1, the space in which the arm 10A can operate, a task of work to be performed on the object 2 by the arm 10A by using the effector 30, and the like, and the arm 10A performs the work based on the teaching. For example, there may be a case in which the arm 10A is disposed at a bar counter. The above described work includes a task of holing the object 2 such as a cup and the like by using the effector 30 in which the arm 10A serves the held object 2 to a position corresponding to a customer at the counter by using the effector 30 as a hand, and the like.

In this case, a visual sensor for observing a working range of the arm 10A is provided, for example, the controller 1 recognizes the position of the effector 30, the position of the object 2, surroundings 4 moving in the space, an approaching object including the customer, and the like based on the output of the visual sensor. The controller 1 sequentially calculates a route along which the effector 30 moves for performing the works while recognizing the surroundings 4 and an existence range of the approaching object. Even in this case, the processor 21 can apply the effector restriction set to the space when the route is generated.

Also, as shown on the screen 307, the user can set a movable range of the effector 30 in the X, Y, and Z directions as the effector restriction 1. It is possible to set “reference” on the screen 307. This “reference” is indicated by, for example, the coordinates in the reference coordinate system 1, the reference coordinate system 101, the effector coordinate system 102, and the like. It is possible to set an “upper limit” and a “lower limit” on the screen 307. The “upper limit” and the “lower limit” are a movable amount or a movable range with respect to the coordinates of the “reference”, for example. In the present embodiment, each movable range, which includes the “reference”, the “upper limit”, and the “lower limit”, for the X, Y, and Z directions is referred to as the effector restriction element. Similarly, the user can set a rotatable range, an angular speed, an angular acceleration of the effector 30 around the X, Y, and Z directions, and the speed and the acceleration in the X, Y, and Z directions of the effector 30 as the effector restriction 1. A value corresponding to an amount obtained by time-differentiating, three times or more, each of the rotatable range around the X, Y, and Z axes of the effector 30, the speed, the acceleration, the angular speed, the angular acceleration, the position, or the orientation, a formula, or the like is also referred to as the effector restriction element.

Also, when the position and orientation of the effector coordinates 1 set as the effector coordinates of the screen 307 are used as the “reference”, when the “reference” is automatically set by the controller 1, and the like, the input and the display of the “reference” can be omitted. Also, it is not necessary to set all the effector restriction elements, and when a part of the effector restriction elements is fixed, the effector restriction elements may automatically be set by the controller 1 and the like.

In the present embodiment, the “reference” can arbitrary be set by the user. For that reason, the user can set the position and orientation of the effector 30 set at each teaching point and the position and orientation different from the positon and the orientation of the effector coordinates 1 set on the screen 307 can be set as the “reference”. This configuration leads to improvement in the flexibility of the setting by the user, the accuracy, the safety, the efficiency, or the like of the operation of the arm 10A. For example, when there is preferable orientation for each type of the effector 30 and the like, the user can set each “reference (standard)” around the X, Y, and Z axes as a neutral orientation of the effector 30. Also, the processor 21 can be configured to conduct a control to make the position and orientation of the effector 30 close to the “reference” (referred to as restoration operation control in this document). With these configurations, it is possible to improve the accuracy, the safety, the efficiency, or the like of the operation of the arm 10A while making it possible to reduce the effort, facilitate the work, or the like for the teaching operation.

Moreover, in the present embodiment, the improvement of the efficiency of the operation of the arm 10A includes improvement in a cycle time of the operation of the arm 10A and the like.

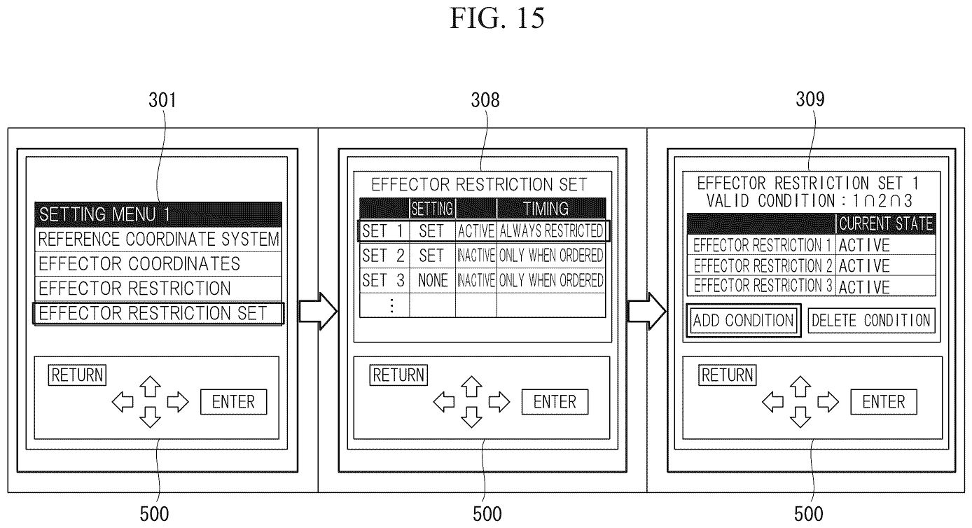

In the present embodiment, when the user selects moving to the setting screen of the effector restriction set in the state where the display is returned to the screen 301 as shown in FIG. 15, the processor 21 causes the display device 22 to display a screen 308 of FIG. 15. The screen 308 is a screen for the user to select the setting of an arbitrary effector restriction set among a plurality of effector restriction sets.

When the user selects a set 1 from the plurality of sets on the screen 308, for example, the processor 21 causes the display device 22 to display a screen 309 of FIG. 15. The screen 309 is a screen for setting the effector restriction set 1 selected by the user, and the user can set the effector restriction set by using the screen 309. The effector restriction set can relate the plurality of effector restrictions to each other.

More specifically, as shown on the screen 309, the user can incorporate the arbitrarily selected effector restrictions 1 to 3 into the effector restriction set 1, and can set “ACTIVE” and “INACTIVE” of each of the effector restrictions 1 to 3. Also, the user can set the relationship of the plurality of effector restrictions 1 to 3 as “1∩2∩3”. “1∩2∩3” means the effector restriction 1 and the effector restriction 2 and the effector restriction 3. For example, the “effector restriction set 1” can be set in an “effector restriction” column on the screen 200 of FIG. 7 instead of the “effector restriction 1” and the like.

This configuration leads to the improvement in the flexibility of the setting by the user. Also, with this configuration, the user can arrange and apply the plurality of effector restriction sets on the screen 307, which leads to the accuracy, the security, the efficiency, or the like of the operation of the arm 10A. Also, in the present embodiment, it is possible to set the “ACTIVE” or the “INACTIVE” of each effector restriction and each effector restriction element on the screens 306, 307, and the like. The setting of the screen 309 can be omitted if necessary.

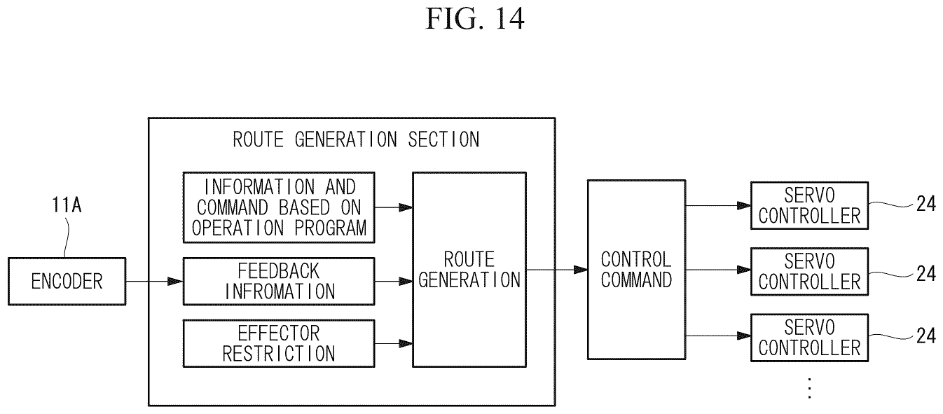

As shown in FIG. 14, the processor 21 uses the route generation program 23D to generate the route for moving the position and orientation of the effector coordinate system 102 from an immediately preceding teaching point to a target teaching point based on the operation program 23B and the like. For example, the processor 21 performs the route generation while performing a known interpolation calculation between the immediately preceding teaching point and the target teaching point.

At this time, the processor 21 performs the route generation while applying the effector restriction as well when there is the effector restriction in the operation program 23B and/or the effector restriction set in the space (range) as describe above. Moreover, in the present embodiment, the route generation may be explained as making a route or creation of a route.

Further, the processor 21 sends the control command corresponding to the generated route to the servo controllers 24.

Even when the robot 10 is a cooperative robot, the processor 21 executes the same or a similar processing. In addition, when the robot 10 is the cooperative robot, the processor 21 may generate an avoidance route for avoiding a target to be avoided.

It may be possible to set any state as long as it is within the range of the effector restriction. Alternatively, when there is a state suitable for the effector 30, this state can be set as a neutral state. For example, when there is a restriction of ±5 deg around the X axis as the effector restriction, if a suitable state is not set, there is a possibility that the effector 30 remains tilted in the end as a result of the route generation. For example, when 0 deg is set as the neutral state, the processor 21 moves the final orientation of the effector 30 so that it becomes close or returns to 0 deg which is described above.

Moreover, when the user sets each teaching point by using a jog operation or a hand guide operation, which will be described later, the position and orientation of the effector 30 at the time of setting the each teaching point may be set as the neutral state. For example, the user places the effector 30 at a first position and orientation by the hand guide operation, and then executes the operation for setting the each teaching point by using the input unit 26, for example. As a result, the first position and orientation is set for the teaching point 1 on the screen 200, for example. The user can set the teaching point 2 and subsequent points in the same or a similar way. When the user sets the each teaching point by using the jog operation or the hand guide operation, the user may image the working arm 10A at the time of work, and place the effector 30 at the actual position and the actual orientation in accordance with the image. As a result, the configuration in which the first position, orientation, and the like are set to be the neutral state at each teaching point is useful for achieving both reduction effort of the user and the accuracy, the safety, the efficiency, or the like of the operation of the arm 10A.

The processor 21 controls the arm 10A to execute the restoration operation control for returning the position and orientation of the effector 30 to be the neutral state. The restoration operation control is performed using at least one of values calculated according to a constant speed or angular speed, a constant acceleration or angular acceleration, a deviation amount from the neutral state, and the like, for example. In order to perform the restoration operation control, a spring-like variable that acts like a spring in accordance with the deviation amount may be used. Further, in order to perform the restoration operation control, a damper-like variable that acts like a damper in accordance with a change of speed or a change of angular speed of the deviation amount may be used. In addition, in order to perform the restoration operation control, an inertial variable that acts like an inertial force according to a change of acceleration or a change of angular acceleration of the deviation amount may be used. A combination of these variables may be used.

As an example of the object handling, the object 2 may be placed on and carried by the effector 30 having a simple tray shape. Since the effector 30 has the tray shape, there is a possibility that the object 2 falls due to an inclination, an inappropriate speed, and the like of the effector 30, which is natural.

For example, the position of the effector coordinates 1 are set at a position slightly higher than the center of gravity of the object 2, and restrictions on the orientation, the angular speed, and the angular acceleration are also set by the screen 305 and screen 307.

Based on the setting, the processor 21 generates a route of the effector coordinate system 102 (effector 30) from a position and orientation to another position and orientation. At this time, the effector 30 on which the object 2 is placed tends to move like a pendulum around the position and orientation in the neutral state set by the effector restriction. This limits a large inclination and acceleration at the position of the object 2, and the object 2 is pressed against the effector 30 by centrifugal force generated by the pendulum operation, which leads to prevention of the object 2 from falling.

In another example, the user can set the effector restriction element with a value equal to an allowable range of acceleration in a direction corresponding to the up and down direction of the effector 30 and in a direction corresponding to the centrifugal force. Also, the user can set an allowable range of acceleration in another direction to a sufficiently small value such as ⅕ or less of the above value. In this case also, the effector 30 tends to move like the pendulum.

Also, the orientation restriction in the effector restriction is not limited to the Euler angle expression, and a quaternion expression and the like can be adopted. The restriction does not have to be a scalar value, and may be set as a function. Also, the restriction does not have to be the scalar value, and may be set as a function. The effector restriction may be set to be switched in accordance with the position, orientation, and the like of the arm 10A. The effector restriction may be set to be switched in accordance with the state of the arm 10A (whether or not the object 2 is held and the like).

When teaching the robot, positions and orientations (X, Y, Z, Θx, Θy, Θz) corresponding to six degrees of freedom are usually designated at each teaching point or over the entire route of the effector 30. When the effector restriction is set, since the effector restriction has an effect of designating the position and orientation, teaching of a position and orientation different from the normal teaching can be conducted.

For example, in many cases of object handling, accurate positioning is required when picking and placing the object 2, but the rough positions and orientations of the effector 30 are required to be determined at other positions. Even in a case in which the rough position (X, Y, Z) is sufficient, it is necessary to designate the positions and orientations for six axes (X, Y, Z, Θx, Θy, Θz) in the conventional teaching method. If the effector restriction restricts the orientations (Θx, Θy, Θz), the teaching only requires the position information (X, Y, Z). In this case, a route from one position to another is generated within the orientation restriction of the effector restriction.

Preferably, a configuration can be employed in which either the original teaching position or the effector restriction is selected in the operation program 23B. For example, a “restriction priority” column is added to the screen 200 of FIG. 7 for setting whether or not the effector restriction has a priority over the designation of the teaching point of the operation program 23B for each teaching point and/or each section of the route. In this case, the user can easily and reliably make a setting where which of the operation program 23B and the effector restriction has the priority. Whether the position and orientation (X, Y, Z, Θx, Θy, Θz) of the effector 30 are restricted by the position and orientation of the operation program 23B or the effector restriction is not limited to the above example.

The above described configuration leads to reduction in the setting of the restrictions at each teaching point. In addition, the above described configuration realizes the operation of the arm 10A that can maintain the position and orientation of the effector 30 in an appropriate state due to the effector restriction, which can lead to the generation, selection, and the like of the route that can improve the cycle time.

Also, as shown on the screens 306 and 307 of FIG. 13, the plurality of effector restrictions can be set in the present embodiment, however, it is also possible to adopt a configuration in which only one effector restriction can be set. Note that the function of the effector restriction is achieved by providing a single set including the reference coordinate system, the effector coordinates, and the effector restriction elements, however, it may be difficult to express various functions by the single effector restriction. Here, as shown on the screens 306 and 307 of FIG. 13, it is possible to adopt a configuration in which a plurality of the effector restrictions can be set. Moreover, it is also possible to adopt a configuration in which a plurality of effector restrictions can be set so as to be applicable at a point such as a section, a range, a teaching point, or the like of each target.

The effector restriction set will be set in the following example. For example, the user sets the effector restriction 1 as a first effector restriction by using the screens 305, 306, and 307. At this time, the user sets the reference coordinate system 1 at a position that does not move with respect to the space, and sets the effector coordinates 1 at an upper portion of the center of gravity of the effector. In the effector restriction 1, a restriction is set so as to allow a translational motion and rotational motion of the effector 30. Moreover, in the effector restriction 1, the restrictions of the angular speed and the angular acceleration are set as well. When the user selects a corresponding tag on the screen 307, the settings of the angular speed, the angular acceleration, and the like will be available.

The user sets the effector restriction 2 as a second effector restriction by using the screens 305, 306, and 307. At this time, the user sets the position and orientation of the effector coordinates 2 as the position and the orientation of the reference coordinate system 2, and sets the effector coordinates 2 at a position located below the center of gravity of the effector. The effector restriction 2 does not allow the translational and rotational motions.

The user sets the effector restriction 3 as a third effector restriction by using the screens 305, 306, and 307. At this time, the user restricts the position and orientation of the effector coordinates 2 with respect to the reference coordinate system 1. In the effector restriction 3, a restriction is set so as to allow the translational motion and the rotational motion. Also, in the effector restriction 3, speed and acceleration of the translational motion are restricted.

When the route is generated based on the setting, the tray like effector 30 on which the object 2 is placed is translated at the effector coordinates 1 and moves like the pendulum, as shown in FIGS. 11 and 12. Also, at the position of the effector coordinates 2, the large translational acceleration is limited. This setting is advantageous for preventing the object 2 from falling. This setting is merely an example, and the contents of the setting are not limited to the above example, and therefore, an arbitrary number of effector restrictions can be set.

In the following example, another setting example of setting the effector restriction set will be described. For example, the user sets the effector restriction 1 as a first effector restriction by using the screens 305, 306, and 307. At this time, the user sets the reference coordinate system 1 at a positon that does not move with respect to the space. Also, the user sets the effector coordinates 1 on a rotational axis line J3 of the joint 3C shown in FIG. 1, and sets the effector restriction 1. The effector restriction 1 is set such that the effector restriction element allows the translational motion and the rotational motion. Moreover, in the effector restriction 1, the angular speed and the angular acceleration are restricted.

The user sets the effector restriction 2 as a second restriction by using the screens 305, 306, and 307. At this time, the user sets the effector coordinates 1 as the reference coordinate system 2, and sets the effector coordinates 2 at a position located below the center of gravity of the effector. In the effector restriction 2, the effector restriction element is set so that the translational motion and the rotational motion are allowed.

The user sets the effector restriction 3 as a third effector restriction by using the screens 305, 306, and 307. At this time, the user restricts the effector coordinates 2 with respect to the reference coordinate system 1. In the effector restriction 3, an effector restriction element is set so as to allow the translational motion. Also, in the effector restriction 3, the effector restriction element is set so as to restrict translational speed and acceleration.

Generally, when the robot moves the joint 3B of FIG. 1 around its rotational axis J2, there is a case where a joint 3C also moves symmetrically around the rotational axis J3, and then the robot may move so as to maintain orientation of the wrist axis. On the other hand, when the robot moves the rotational axis line, this effect does not occur in many cases. In the conventional setting, it is difficult to execute the operation around the rotational axis line J3 while maintaining the orientations of the movable portion 12 (J2 arm), which is located between the joint 3B and the joint 3C as they are, and the wrist.

When the effector restriction set of the other setting example described above is set, the rotation at the position of the effector coordinates 2 are restricted when the rotation operation around the rotational axis J3 is executed. This configuration and setting are useful for preventing the object 2 from falling.

Since the user sets the effector restrictions separately from each other, it becomes easy to divide the operation according to an idea and the like of the user, and it also becomes easy for the user to understand the setting of the effector restrictions. This configuration is useful for risk assessment of the robot, and also useful for reducing errors related to the teaching and the setting of the operation of the arm 10A.

In the present embodiment, a set of the reference coordinate system, the effector coordinates, and the effector restriction may be referred to as an effector restriction as one unit. Also, the effector restriction is a group of individual restrictions such as a position, speed, acceleration, and the like, and each restriction is referred to as an effector restriction element. A plurality of effector restrictions may be prepared, and the processor 21 reads and uses a necessary effector restriction from the storage unit 23.

A plurality of effector restriction sets corresponding to various states of the arm 10A may be prepared. The state of the arm 10A varies depending on the type of the effector 30, the type of the object 2, the type of the arm 10, and the like. The effector restriction set is a combination of two or more effector restrictions. In addition, if one or more effector restriction sets have been prepared for each state of the arm 10A or for each operation program 23B, the user only have to use the prepared effector restriction set. This configuration leads to a reduction in the time of setting by the user, and also leads to the accuracy, the safety, the efficiency, or the like of the operation of the arm 10A.

By setting the effector restriction, it is possible to generate a route considering characteristics of the effector 30, the object 2, and the like, however, it is difficult to accurately reflect the characteristics of the effector 30, the object 2, and the like on the effector restrictions. In some cases, the user can determine the effector restriction by using calculation and the like, however, the accuracy of the effector restriction varies due to a difference in experience of each user. In such a situation, trial and error is required to input the effector restriction. In addition, there is a possibility that the setting of the originally necessary restriction is omitted and an unintended failure is caused. Those situations can be improved by the following configuration.

### Priority

In the present embodiment, the effector restriction includes a plurality of effector restriction elements, and as shown on the screen 307 of FIG. 13, a priority can be set to at least one of the plurality of effector restriction elements. For example, the screen 307 has a “priority” column, and the priority can be set so as to correspond to each effector restriction element. On the screen 307, the priority of “absolute” is set to the “upper limit” and the “lower limit” of the angle around the X axis which is the effector restriction element. It can be said that the priority of “absolute” is, for example, an indispensable setting that must be used by the processor 21. The priorities are also set for other effector restriction elements, and “absolute”, “high”, and “low”, which is written in descending order of priority, are set.

This configuration increases the flexibility of the setting by the user. Also, the robot 10 can operate under a condition that any one of the rotational position restrictions of X, Y, and Z in the effector restrictions is not necessarily used, and options of the routes that can be set by the processor 21 increase. Also, the processor 21 can select a more effective route that can improve the cycle time and the like.

The effector restrictions in the present embodiment have priorities, such as a restriction that should always be kept, a restriction that is not necessarily kept, and the like. When the route is generated, it may be desired to keep all the restrictions, however, there is also a possibility that an effective route cannot be selected in order to keep a less important restriction. In other words, there is a case in which an effective route can be selected by not keeping the restriction with a low priority. For that reason, the processor 21 may be configured not to keep the restriction with the low priority based on a preset criterion. In order to realize this configuration, the priority is set for each effector restriction and each effector restriction element, and the priority is stored in the storage unit 23.

When the user uses a preset effector restriction as described later, the preset can be prepared so that the effector restriction elements have different priorities. The effector restriction element that is the more important in satisfying the functional requirement has the higher priority. The priority can be changed later by the user.

The effector restriction includes a restriction that is intentionally set by the user and a restriction that is not intentionally set by the user. In the preset embodiment, a restriction that is intentionally set by the user (user ordered restriction) may be referred to as a designated restriction and an optimizable restriction that is not intentionally set (optimizable restriction) may be referred to as a submissive restriction. Information indicating whether the restriction is the designated restriction or the submissive restriction may be stored in the storage unit 23 together with the effector restrictions. For example, for each of the effector restriction elements, the controller 1 receives a setting of a restriction element that causes the processor 21 to use a value designated by the user or a setting of a restriction element that allows a change by the processor 21, and the received setting is stored in the storage unit 23. These settings are indicated as “designated” and “submissive” in FIGS. 13, 19, and 23.

When the user uses the preset effector restriction as described later, since the details of the effector restriction is not set by the user, it is desirable to use the submissive restriction first. When the user edits the preset effector restriction, this effector restriction will become a designated restriction. The user can later change whether the effector restriction is the designated restriction or the submissive restriction.

Further, the priority of the effector restriction and the distinction between the designated restriction and the submissive restriction can be set for each effector restriction element, or they can be collectively set for each effector restriction set.

In the case of having a plurality of effector restriction sets, an intention of the restriction can easily be understood by making the priority and the distinction between the designated restriction and the submissive restriction.

### Preset

In the present embodiment, preferably, a preset automatic setting program 23F for automatically setting the effector restriction and/or the effector restriction element is stored in the storage unit 23. The preset automatic setting program 23F automatically sets the effector restriction and/or the effector restriction element based on information of the effector 30 and the object 2 that can objectively be obtained by the user and function and performance (functional requirement) that are subjectively expected by the user.

The functional requirement may be a qualitative expression such as “do not want to shake”, “do not want to topple”, “do not want to drop”, “do not want to tilt”, “do not want to move it from the current position”, and the like for the object 2, for example.

This functional requirement can be expressed as the effector restriction element. For that reason, a preset effector restriction element corresponding to the functional requirement is stored in the storage unit 23 in advance.

In this case, for example, it is configured that the user can select a type of a combination of the effector 30 and the object 2 from a plurality of types of presets. As the presets, there are a type of placing on a tray, a type of placing on a container, a type of putting in a box, a type of holding with a hand, a type of sucking, and the like. Also, as the presents, there are a type of processing an object with a welding gun, a type of processing an object with a welding torch, a type of machining an object with various tools, and the like. This configuration does not limit the type of the effector 30, and the preset is for assisting information input. An effector that does not correspond to the presets can also be used.

It is also desirable to use a 3D-CAD model of the effector 30 and the object 20. In addition to the shape, a position of a center of gravity of the object 2, its weight, a position of a center of gravity of the effector 30, its weight, a movable portion of the effector 30, and the like are used together with the 3D-CAD model to create a more accurate physical model. It is desirable that the physical mode is provided with parameters necessary for explaining physical behavior, such as a spring constant indicating hardness of a material, an attenuation coefficient for attenuating vibration, a friction coefficient when objects rub against each other, and the like. With the physical model, it is possible to reproduce physical behavior such as behavior of gripping with a hand, behavior of dropping the object 2, and the like on a simulation.

The physical model used in the present embodiment is to execute the physical simulation. Since various settings of the physical model require man-hours, it is desirable that the physical model can be constructed from information that can easily be obtained by the user.

For a typical type of the effector 30 and the object 2, an rough arrangement of the effector 30 and the object 2 is determined by selecting the preset of the combination type of the effector 30 and the object. If the arrangement is determined, an approximate physical model is generated simply by adding the shape, the center of gravity, the weight, and the like of a characteristic portion of the effector 30 and the object 2.

The controller 1 stores the information such as the type, the shape, and the like of the effector 30 and the object 2, the information of the functional requirement, and the information of the effector restriction element appropriate for realizing the functional requirement in a state of being associated with each other in the storage unit 23. The processor 21 sets the effector restriction element on the basis of the above mentioned information, the functional requirement input by the user, the information of the physical model, and the like, and presents the effector restriction element to the user.

More specific examples are described below.

For example, a screen for setting using the preset is displayed on the display device 22 of the input unit 26.

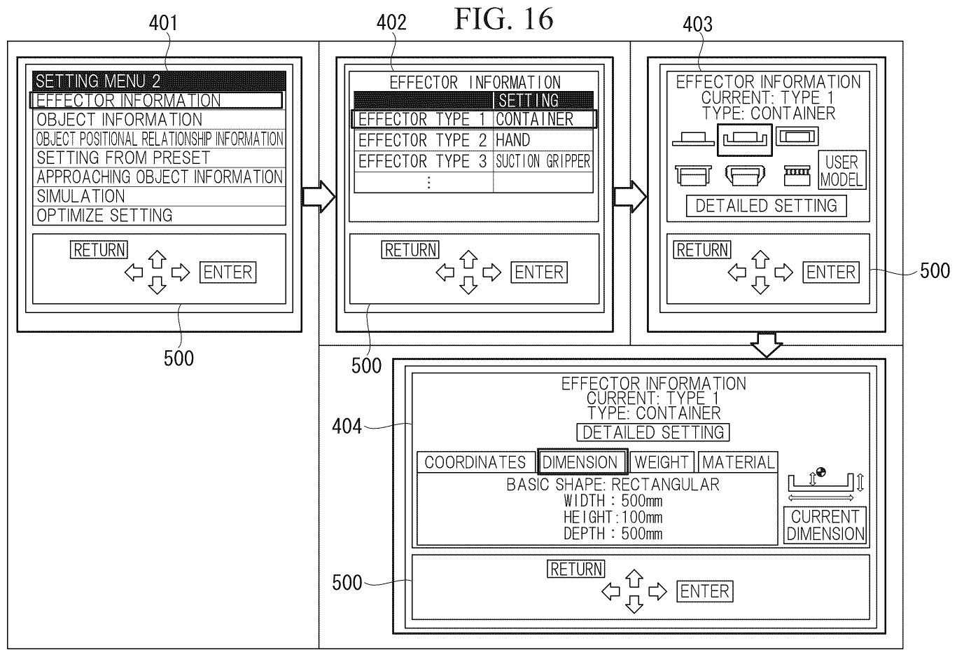

First, the processor 21 of the controller 1 causes the display device 22 to display a screen 401 shown in FIG. 16. The screen 401 may be displayed instead of the screen 301. The screen 401 may be displayed instead of the screen 301. The screen 401 is a screen for the user to select moving to the effector information setting screen.

When the user selects moving to the effector information setting screen on the screen 401, the processor 21 causes the display device 22 to display a screen 402 of FIG. 16. The screen 402 is a screen for the user to select an arbitrary effector type setting from a plurality of effector type settings.

When the user selects the setting of the effector type 1 on the screen 402, the processor 21 causes the display device 22 to display a screen 403 of FIG. 16. The screen 403 is a screen for setting the effector type 1 selected by the user. As shown on the screen 403, the user can set the effector type by selection.

When the user selects the detailed setting of the selected effector type on the screen 403, the processor 21 causes the display device 22 to display a screen 404 of FIG. 16. The screen 404 is a screen for setting a dimension of the selected effector type and setting a position such as a position of the center of gravity and the like. Preferably, the screen 404 is configured so that a weight, a material, and the like of the selected effector type can also be set.

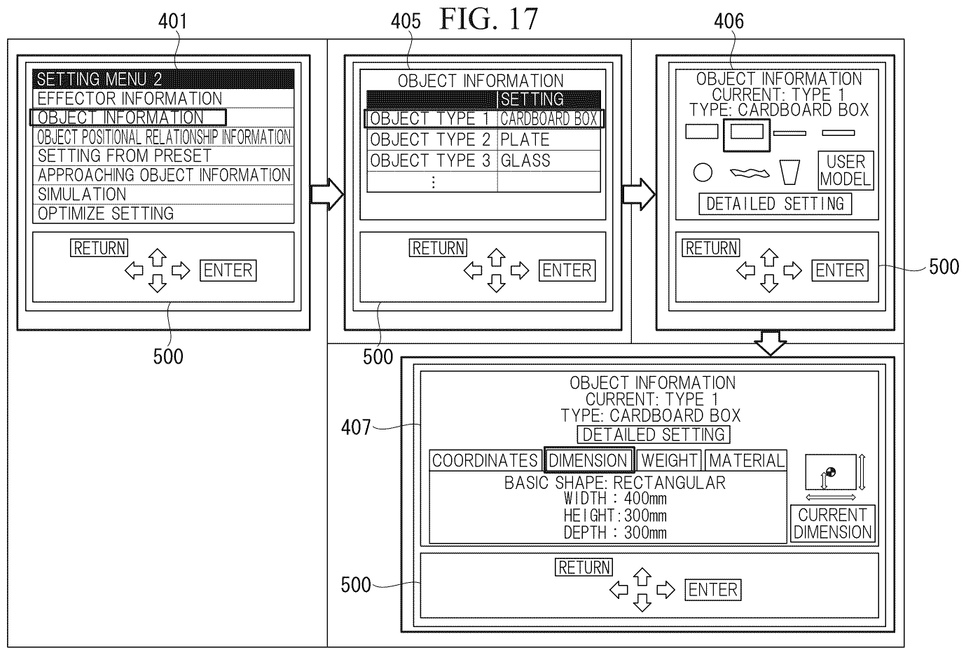

As shown in FIG. 17, in a state where the display is returned to the screen 401, when the user selects moving to the object information setting screen, the processor 21 causes the display device 22 to display a screen 405 of FIG. 17. The screen 405 is a screen for the user to select an arbitrary object type setting from the plurality of object type settings.

When the user selects setting of an object type 1 on the screen 405, the processor 21 causes the display device 22 to display a screen 406 of FIG. 17. The screen 406 is a screen for the user to set the selected object type 1. As shown on the screen 406, the user can set an object type by selection.

When the user selects a detailed setting of the selected object type on the screen 406, the processor 21 causes the display device 22 to display a screen 407 of FIG. 17. The screen 407 is a screen for setting a dimension of the selected object type, setting a position such as a position of the center of gravity, and the like. Preferably, the screen 407 is configured so that weight, a material, and the like of the selected object type can also be set. Also, the screen 407 may be configured so that a position of the selected object type with respect to the selected effector type can also be set.

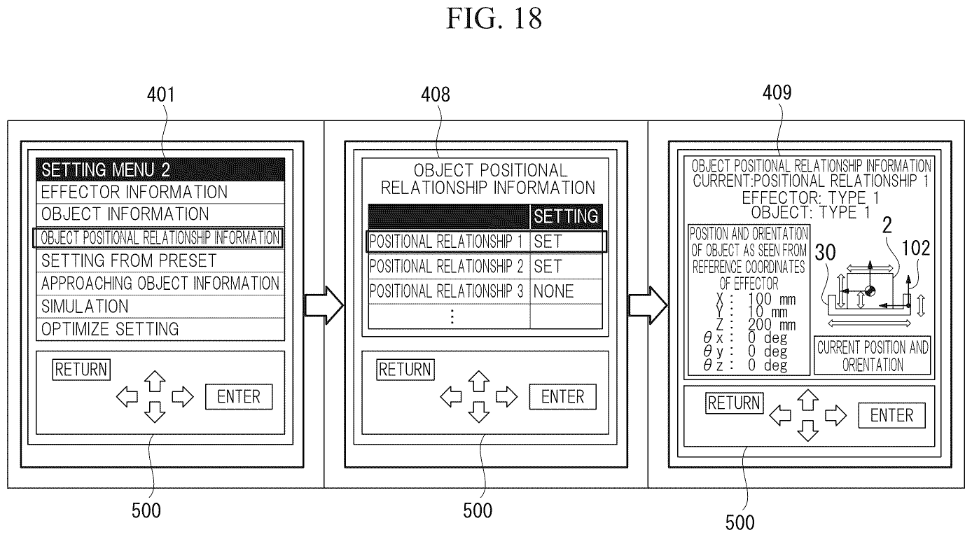

As shown in FIG. 18, in the state of returning to the screen 401, when the user selects moving to a setting screen of object positional relationship information, the processor 21 causes the display device 22 to show a screen 408. The screen 408 is a screen for setting the positional relationship of the selected object type with respect to the selected effector type.

When the user selects a setting of a positional relationship 1 on the screen 408, for example, the processor 21 causes the display device 22 to show a screen 409 of FIG. 18. The screen 409 is a screen for setting the positional relationship 1 selected by the user. As shown on the screen 409, the user can set the positional relationship by entering a numerical value and moving a displayed figure of the effector and/or a displayed figure of the object.

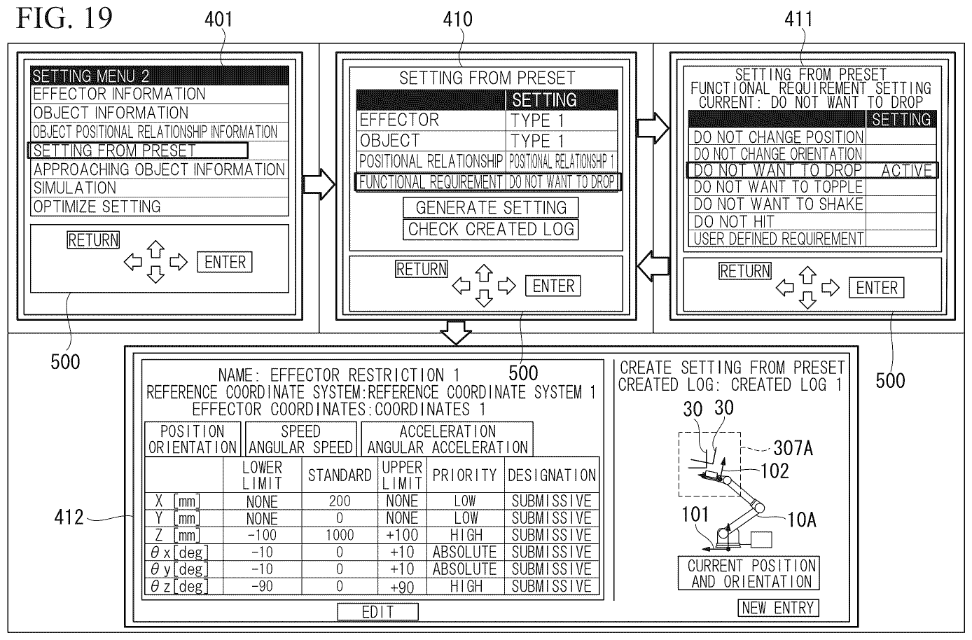

As shown in FIG. 19, in the state where the screen has returned to the screen 401, when the user selects moving to a setting screen for setting the effector restriction from the preset, the processor 21 causes the display device 22 to display a screen 410 of FIG. 19. The screen 410 is a screen for selecting the effector type, the object type, the object positional relationship, and the like.

Note that when the effector type is fixed, the information of the effector type may automatically be set based on input information (an input) from an external device. For example, a signal may be sent from the effector 30 to the controller 1 when the effector 30 is connected to the controller 1, and the processor 21 may set the effector type based on the input signal (input). Similarly, when the object type and the object positional relationship are fixed, the object type and the object positional relationship may automatically be set.

The screen 401 is a screen to select moving to a functional requirement setting (requirement) screen and a screen for displaying the set functional requirement. When the user performs a predetermined operation for setting the functional requirement, for example, when the user presses a “generate setting” button, the processor 21 causes the display device 22 to show a screen 411 of FIG. 19. The screen 411 is a screen for the user to select the functional requirement. The screen 411 displays “ACTIVE” indicating each of the functional requirements has been set at each of positions corresponding to the functional requirements. The user can also set a plurality of functional requirements on the screen 411. The functional requirement (requirement) is a requirement of the user related to work to be performed on the object 2 by the effector 30, for example.

The effector restrictions are set by the settings of the screens 410 and 411. The effector restrictions include the settings similar to those of the screen 307, for example. For that reason, the processor 21 can control the arm 10A by using the set effector restrictions.

In the state where the screen has returned to the screen 410, when the user presses “view generated log”, the processor 21 causes the display device 22 to show a screen 412 of FIG. 19. The screen 412 displays the content of the set effector restriction and accepts changes of each of the effector restriction settings. The screen 412 is configured so as to receive an input of the user for registering, as one of the presets, the effector restrictions in which settings have been changed.

In this manner, the storage unit 23 stores the plurality of effector restrictions. Also, the plurality of effector restrictions are stored in the storage unit 23 so as to respectively correspond to the plurality of combinations of the effector types, which are the types of the effector 30, and the object types, which are the types of the object 2. And, when the user inputs an arbitrary combination by using the input unit 26 and the like, the processor 21 sets the corresponding effector restriction. This configuration leads to reduction in the time and effort of the setting by the user, and also leads to the accuracy, the safety, the efficiency, or the like of the operation of the arm 10A.

Note that, the effector restriction may be set based only on the effector type setting. Alternatively, the effector restriction may be set based only on the setting of the object type. For example, in the case of the effector type or the object for each of which a task and its requirement are fixed, the effector restriction is set based only on the effector type setting or the object type setting in a state in which there is no other setting such as a functional requirement and the like. In this configuration, the user may make an input for setting the effector type or the object type. That is, the processor 21 sets the effector restriction based on at least one of the information about the effector type and the information about the object type, and the input for the setting by the user. When the effector 30 is connected to the controller 1, information, a signal and the like related to the effector type may be input to the controller 1 from the effector 30, which is an external device. In this case, the processor 21 sets the effector restriction based at least on the information related to the effector type and the input from the external device. These configurations lead to further reduction in the time and effort of the settings by the user, and also contribute to the improvement in the accuracy, the safety, the efficiency, or the like of the operation of the arm 10A. Further, even a user who lacks sufficient experience can appropriately perform the effector restriction, which is useful for the accuracy, the safety, the efficiency, or the like of the operation of the arm 10A.

In addition, in the present embodiment, the effector restriction is also set based on a requirement input by the user. This configuration is useful for achieving both the reduction of the time and effort of the setting by the user and the improvement of the accuracy, the safety, the efficiency, or the like of the operation of the arm 10A at a high level.

### Simulator

In the present embodiment, as described above, the effector restriction is set by the input value of the user, and the preset effector restriction is set based on the functional requirement input by the user. However, even in the case of the preset, the set effector restriction does not necessarily function normally as expected by the user. There is a possibility that the route assumed by the user is not obtained due to omission of an important setting, presence of an unnecessary setting, insufficiency of fine adjustment of the effector restriction element, and the like.

The most reliable confirmation method is to confirm an operation route by using an actual robot 10. However, if the there is a deficiency in the setting, the confirmation action itself becomes a risk. Therefore, checking whether or not the effector restriction is appropriate on the simulation reduces the risk.

In order to perform the simulation, the user needs to input an operation pattern (operation program 23B) of the arm 10A. On the other hand, there may be an infinite number of operation patterns of the jog operation, the hand guide operation, and the like. Therefore, preferably, sets of various operation patters of the arm 10A are prepared as presets in advance. The user normally selects an arbitrary operation pattern from the presents, and in an exceptional individual case, the user creates or modifies a supplementary operation pattern by input.

3D models of the surroundings 4, the approaching object including a person or an object carried by a person, the robot 10, the effector 30, the object 2, and the like are reproduced on the simulator, and a simulation of the operation such as the automatic operation, the jog operation, the hand guide operation, and the like is conducted. The simulation is preferably a physical simulation capable of reproducing the falling of the object 2, and the like. For example, physical models of the effector 30 and the object 2 that have been created are utilized.

The simulation can calculate the acceleration and the like of the effector 30 and the object 2 that cannot be monitored normally in reality. A simulation allowable value is set as an allowable threshold value for the position, the orientation, the speed, the acceleration, the angular speed, the angular acceleration, and the like of the effector 30 and the object 2. The simulation can confirm whether or not the operation of the effector 30 is within the simulation allowable value. When a simulation allowable value corresponding to the functional requirement is prepared in advance, the allowable value may be used. Alternatively, a value, a setting, and the like used as the simulation allowable value may be selected from the effector restriction set.

As a result of the simulation, there is a possibility that a defect of the work such as overturning, falling, and the like of the object 2 may occur. The simulation can determine whether or not the functional requirement is satisfied under an arbitrary condition assumed by the user. Preferably, the processor 21 displays a state of the operation on the simulation on the display device 22 and the like.

In a case in which a requirement of the simulation allowable value is not satisfied, or in a case in which the cycle time does not satisfy a condition, it is possible to improve by reviewing the effector restriction element. The user can confirm the state of the simulation and finely adjust the effector restriction element.

Based on the result of the simulation, the processor 21 can modify, improve, or optimize the effector restriction, which will be described later, based on a restriction modification program 23G. This configuration is useful in achieving both the reduction in time and effort of the user, and improvement of the accuracy, the safety, the efficiency, or the like of the operation of the arm 10A.

For example, the above described fine adjustment of the effector restriction element by the user is performed by trial and error, and a large burden will be applied on the user. In a case in which the priority, a degree of importance, and the like are set at the time of setting the effector restriction elements, there is a high possibility that the effector restriction elements having a low priority among the effector restriction elements having a low degree of importance are changed. This is the effector restriction element to be adjusted. The restriction modification program 23G for modifying the effector restriction sets based on the simulation result is stored in the storage unit 23.

The simulation may be performed, and a magnitude of the risk when the requirement of the simulation allowable value is not satisfied may be used as a criterion for determining whether the effector restriction set is good or not. Moreover, the cycle time may also be the criterion for determining whether the effector restriction set is good or not. The above mentioned criterion for determining whether the effector restriction set is good or not is just an example, and it is not limited to them. An effector restriction set index can be set as a determination index for determining whether the effector restriction set is good or not by incorporating a determination criterion of a risk assessment of the user and the like.

For example, it is possible to define that a condition in which the effector restriction set index becomes maximum (or minimum) is the best effector restriction set.

As a modification method example of the effector restriction set by using the simulation, the following method can be considered. First, a general genetic algorithm can be applied. After the simulation is carried out, the effector restriction set index is calculated. Based on the simulation result, an alternative for the effector restriction element to be adjusted is created. A plurality of the alternatives may be created at a time.

The simulation is carried out again by using the alternative effector restriction element, and the effector restriction set index is calculated. The alternative will further be created based on the effector restriction set in which the effector restriction set index has been improved. It is possible to change the number of the alternatives to be created according to the improvement degree of the effector restriction set index.

The generation of the alternatives of the effector restriction sets as described above may be carried out a predetermined number of times or until a predetermined effector restriction set index is exceeded. With this processing, an effector restriction set suitable in terms of the cycle time and the like can be obtained. The above described processing is just an example and is not limited to this specific processing.

The above described simulation and the improvement or the optimization of the effector restrictions based on the simulation result may be performed by the processor 21 of the controller 1 or by another computer. The other computer has a processor, a display device, a storage unit, an input unit, and the like that are the same as or similar to those of the controller 1. The store unit of the other computer stores a program, data, information, and the like that are the same as or similar to those of the storage unit 23. Further, the storage unit of the other computer also stores the simulation program and models of the surroundings 4, the robot 10, the effector 30, the object 2, and the like.

The effector restriction improved or optimized by the other computer may be input to the controller 1, and the processor 21 of the controller 1 may set the input effector restriction in the operation program 23B and the like when the input is received. In this case, based on the input from the computer as the external device, the processor 21 causes the arm 10A to execute the operation restricted by the effector restriction.

A more specific example will be explained below.

For example, a screen for performing the simulation of the effector restriction is displayed on the display device 22 of the input unit 26.

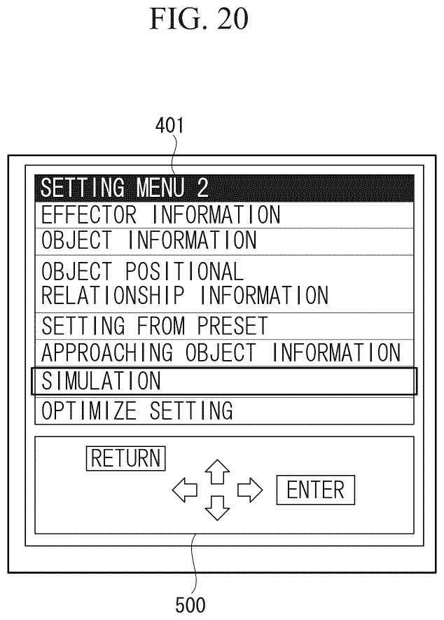

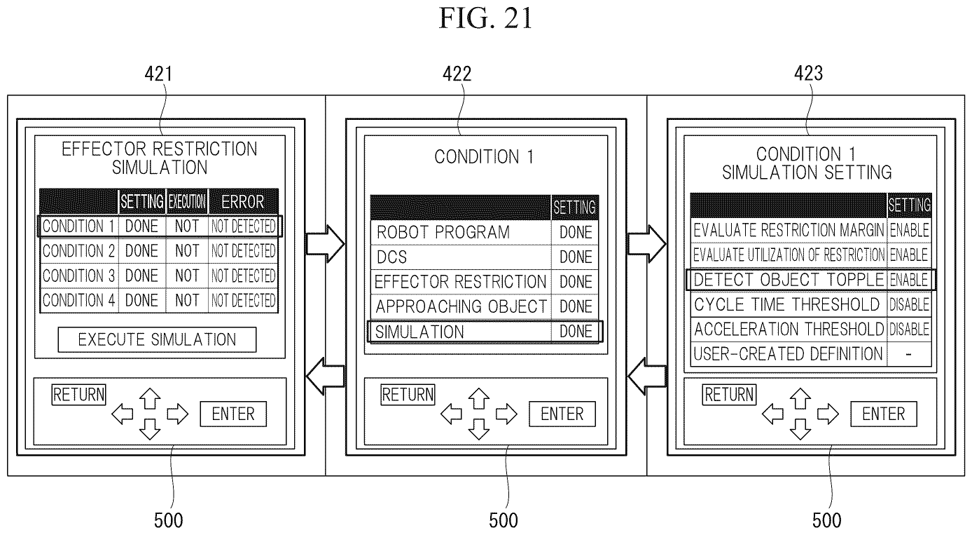

When the user selects moving to the screen of the effector restriction simulation on the screen 401 shown in FIG. 20, the processor 21 causes the display device 22 to show a screen 421 of FIG. 21. The screen 421 is a screen for the user to select a setting of an arbitrary simulation condition among a plurality of simulation condition settings.

When the user selects the setting of a simulation condition 1 on the screen 421, the processor 21 causes the display device 22 to show a screen 422 of FIG. 21. The screen 422 is a screen for making various settings for the simulation. When the user selects the simulation setting on the screen 422, the processor 21 causes the display device 22 to show a screen 423. The screen 423 is a screen for setting evaluation items to be evaluated in the simulation, for setting conditions for each evaluation item including the setting of the simulation allowable value, and the like.

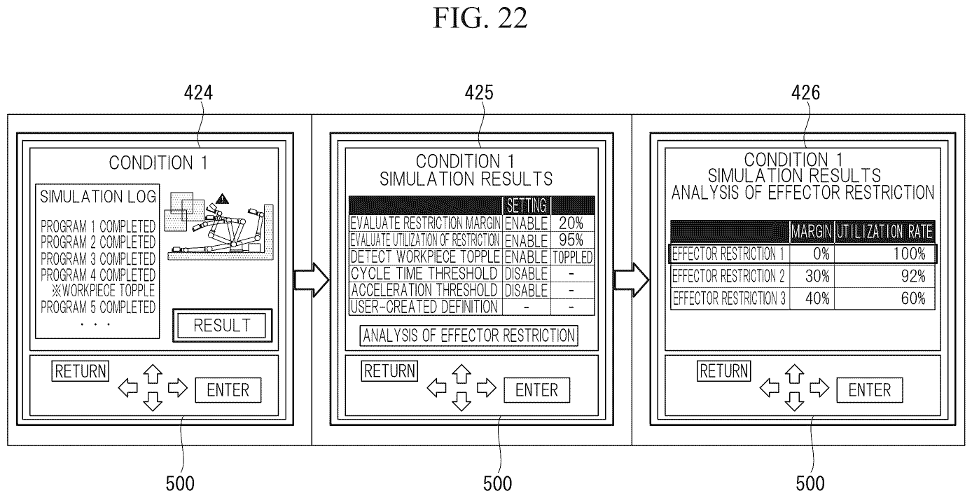

The user performs the operation for executing the simulation on the screen 421 after making the settings on the screens 422 and 423. As a result, the processor 21 displays a simulation execution screen 424 of FIG. 22, and displays results of the evaluation items set on screens 425 and 426 of FIG. 22.

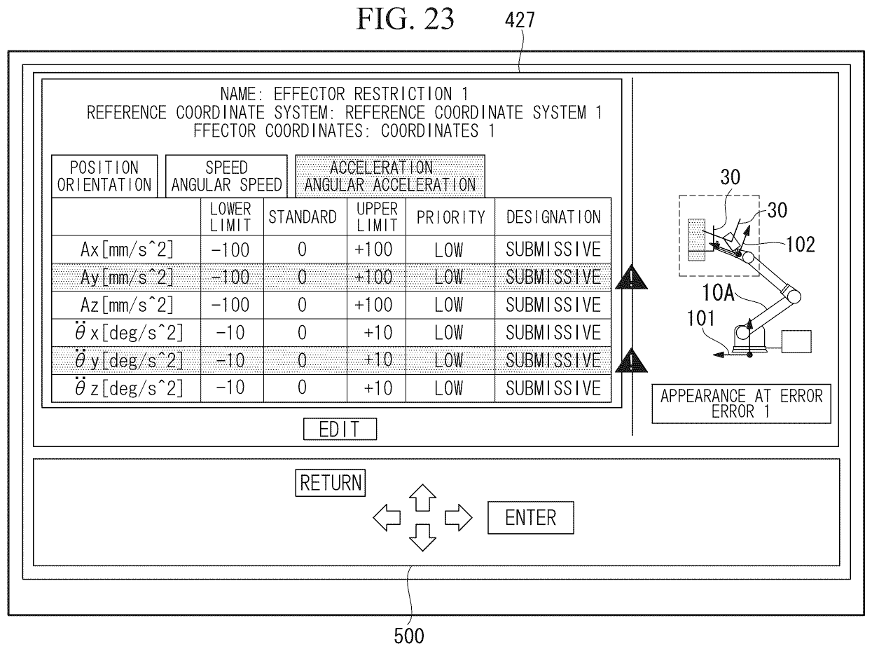

In addition, the processor 21 may evaluate whether or not the operation of the effector 30 is within the simulation allowable value. And, the processor 21 may display a screen 427 of FIG. 23 when the operation of the effector 30 is not within the simulation allowable value. When the operation of the effector 30 is not within the simulation allowable value, the processor 21 may determine or estimate an effector restriction element that is the cause of the result, and display a screen to indicate the effector restriction element for the user as shown on the screen 427. On the screen 427, the effector restriction element that is determined to be the cause is displayed in a different color.

The processor 21 can improve or optimize the effector restriction by using the simulation result based on the restriction modification program 23G. For example, when “setting optimization” is selected on the screen 401, the effector restriction will be improved or optimized.

A case in which the simulation is performed using the effector restriction 1 of the screen 307 of FIG. 13 will be explained as an example. When some of the effector restriction elements of the effector restriction 1 are determined as the cause, the processor 21 modifies the effector restriction elements that are determined to be the cause. At this time, as described above, each effector restriction element of the screen 307 of FIG. 13 is set to “designate” meaning the designated restriction (user ordered). Moreover, it is assumed that some of the effector restriction elements in the acceleration/angular acceleration tab and the like of the screen 307 of FIG. 13 are the causes as shown in FIG. 23, and they are not set to “designate”, that is, they are the submissive restrictions (optimizable). For example, the processor 21 executes the improvement or the optimization by modifying the effector restriction elements that are determined to be the cause and which are not set to “designate”. In this case, the user can instruct the processor 21 to carry out the improvement or the optimization while recognizing the restriction elements that are that are not automatically modified. This configuration facilitates the setting of the user, and also leads to the accuracy, the safety, the efficiency, or the like of the arm 10A.

### Jog Operation and Hand Guide Operation

The jog operation is an operation in which the user moves the arm 10A directly by using a direction key, a joy stick, and the like of the input unit 26. For that reason, if the user does not understand the characteristics of the arm 10A or does not observe the surroundings 4 sufficiently, an operation error that causes contact between the arm 10A or the effector 30 and the surroundings 4, displacement of the effector 30 to an undesirable orientation, and the like is likely to occur. In the present embodiment, it is possible to set the application of the effector restriction even during the jog operation.

The processor 21 controls the arm 10A so that the arm 10A is within the range of the effector restriction even during the jog operation, and the arm 10A operates in this way. This reduces or prevents the effector 30 from being in an unintended orientation due to the operation error and the like. Also, since the operation of the effector 30 is restricted by the effector restriction, the number of checking steps by the user at the time of jog operation is reduced.

Also, when the above mentioned neutral state setting is set in the effector restriction, the processor 21 operates the arm 10A so as to bring the orientation of the effector 30 close to the neutral orientation at the time of jog operation. With this configuration, the effector 30 can be maintained in a state close to preferable orientation without requiring the user to perform special operation with the direction key, the joy stick, and the like.

When the user teaches the robot and the like, there is the hand guide operation in which the user holds the distal end portion of the arm 10A and the user moves the arm 10A by applying an external force to the distal end portion. In the hand guide operation, the direction and the magnitude of the external force are detected by the sensor, and the processor 21 moves the arm 10A in the direction of the external force according to a detection result of the sensor. In the hand guide operation as well, the operation error may occur if the user applies the external force in a wrong direction. In the present embodiment, it is possible to make a setting to apply the effector restriction also at the time of the hand guide operation, and the same or similar effect as the jog operation can be achieved at the time of the hand guide operation as well.

Jog Operation and Hand Guide Operation with Interference Calculation

When the jog operation and the hand guide operation are performed, it is important that the arm 10A of the robot 10 and the effector 30 do not come into contact with the surroundings 4. If it is not clear that they do not come into contact, it is desirable to execute interference calculation. In this case, in the controller 1, the processor 21 performs the interference calculation based on an interface calculation program 23H stored in the storage unit 23.

Basic information required for the interference calculation will be described below.

First, a 3D model of the robot 10, a 3D model of the effector 30, and a 30D model of the object 2 which is the workpiece are stored in the storage unit 23. In object handling and the like, the object 2 is not always held, but there is a case in which the object 2 is integrated with the surroundings 4, and in particular, there is a case in which the object 2 is being moved on a conveying device or held by another robot system. For that reason, it is preferable to distinguish the state between the object 2 moving together with the effector 30 (object at the effector side) and the object 2 moving together with the surrounding object 4 (object at the surroundings side).

A 3D model corresponding to the surroundings 4 is also stored in the storage unit 23, and this 3D model is also used for the interference calculation. Here, in order to limit the operation of the arm 10A, it is general to set an entrance-prohibited area virtually. In the present embodiment, the processor 21 calculates the distance among the models based on the interference calculation program 23H by using the control command of the robot such as the operation program 23B, the effector 30, the object 2, the surroundings 4, and the like. In principle, the processor 21 stops the arm 10A safely when the result of the interference calculation is below an allowable value of distance to which they can approached to each other.

Here, there is a case in which the interference can be avoided by the processor 21 operating the arm 10A within the range of the effector restriction as in the present embodiment. For example, there is a case in which interference between the 3D model of the effector 30 and a 3D model corresponding to the surroundings 4 is likely to occur at the time of the jog operation or the hand guide operation. At this time, the processor 21 can move the arm 10A so as to avoid contact with the surroundings 4 within the range of the effector restriction. Basically, the processor 21 stops the arm 10A if there is no effector restriction, however, since the processor 21 can move the arm 10A as described above, the jog operation or the hand guide operation by the user will not be interrupted. This configuration allows the effective and flexible jog operation and hand guide operation.

In the present embodiment, the storage unit 23 stores the effector restriction that is the restriction of the changes in the position and orientation of the effector 30 as seen from the predetermined reference coordinates. Also, the processor 21 causes the robot 10 to execute the operation that is restricted by the effector restriction set based on the input from the user or the external device. This leads to the accuracy, the safety, the efficiency, or the like of the operation of the robot 10. For example, it becomes easy or reliable to set orientation to be avoided (avoidance) according to the type of the effector 30 and the object 2. Further, reducing labor of the user, facilitation, and the like of the teaching operation or the setting operation which are described above. In addition, it may lead to the creation, the selection, and the like of an avoidance route that can improve the cycle time while realizing the operation of the arm 10A that can maintain the position and orientation of the effector 30 in an appropriate state.

Further, the controller 1 includes the input unit 26 for the user to input the effector restriction element and the like of the effector restriction. This configuration is useful in setting the appropriate effector restrictions for a wide variety of the effectors 30 and a wide variety of works.

Also, in the effector restriction, at least one of the restriction of the speed, the restriction of the acceleration, the restriction of the angular speed, and the effector restriction element of the angular acceleration as seen from the predetermined reference coordinates of the effector 30 can be set. This configuration is useful in setting the appropriate effector restrictions for a wide variety of the effectors 30 and a wide variety of works. Moreover, the settings of these effector restriction elements may facilitate the operation setting or the setting of the operation restriction of the arm 10A when a large number of teaching points and the like are set for a complicated operation of the arm 10A, for example.

While the embodiment of the present disclosure has been described in detail, the present disclosure is not limited to the individual embodiments described above. Various additions, substitutions, changes, partial deletions, and the like can be made to the embodiment within a range not departing from the gist of the invention, or within a range not departing from the concept and purport of the invention derived from the contents described in the claims and their equivalents. For example, in the above described embodiment, it is possible to change the order of operations, change the order of processing, omit or add a part of works according to conditions, and omit or add a part of processing according to conditions without being limited to the above described example. The same applies to the case where numerical values or mathematical expressions are used in the description of the above described embodiment.

### APPENDIX 1

A controller comprising:
a processor; and
a storage unit storing an effector restriction which is a restriction on a change in at least one of a position or an orientation of an effector of a robot as seen from predetermined reference coordinates, wherein
the processor is configured to cause the robot to execute an operation restricted by the effector restriction which is set based on an input by a user or from an external device.

### APPENDIX 2

The controller according to appendix 1, wherein the storage unit can store a plurality of the effector restrictions.

### APPENDIX 3

The controller according to appendix 1 or 2, wherein the storage unit is capable of storing an effector restriction set made by combining the plurality of effector restrictions.

### APPENDIX 4

The controller according to appendix 3, wherein the storage unit is capable of storing a plurality of operation programs for operating the robot and the plurality of effector restriction sets respectively corresponding to the plurality of operation programs.

### APPENDIX 5

A controller comprising:
a processor;
a storage unit; and
a display device which displays a setting screen of an effector restriction which is a restriction on a change of at least one of a position or an orientation of an effector of a robot as seen from predetermined reference coordinates, wherein
the setting screen is for setting the effector restriction based at least on an input by a user.

### APPENDIX 6

The controller according to any one of appendixes 1 to 5 comprising an input unit which enables input of the effector restriction.

### APPENDIX 7

The controller according to any one of appendixes 1 to 6, wherein
the storage unit stores a plurality of the effector restrictions,
the plurality of effector restrictions respectively correspond to at least one of a type of the effector and a type of an object to which the effecter conduct an operation, and
the processor is configured to set the effector restrictions based at least on one of information regarding the type of the effector or information regarding the type of the object, and an input by the user.

### APPENDIX 8

The controller according to appendix 7, wherein the input by the user is for setting a requirement required by the user regarding the operation by the effector.

### APPENDIX 9

The controller according to any one of appendixes 1 to 6, wherein the effector restriction includes a plurality of effector restriction elements,
the effector restriction is one to which a priority can be set to at least one of the plurality of effector restriction elements, and
the processor is configured to operate the robot by using at least the effector restriction including the priority.

### APPENDIX 10

The controller according to any one of appendixes 1 to 6, wherein
the effector restriction includes a plurality of effector restriction elements,
the controller is configured, for each of the plurality of effector restriction elements, to accept a setting of a designate restriction that causes the processor to use a value designated by the user or a setting of a submissive restriction that allows a change by the processor.

### APPENDIX 11

The controller according to any one of appendixes 1 to 10, wherein
the processor performs a simulation that causes a model of the robot to perform the operation by using at least the effector restriction, and determine whether or not the operation satisfies a criterion.

### APPENDIX 12

The controller according to appendix 11, wherein the processor is configured to modify the effector restriction to satisfy the criterion when the operation does not satisfy the criterion.

### APPENDIX 13

The controller according to any one of appendixes 1 to 12, wherein the effector restriction is capable of setting at least one of a restriction of speed as seen from the predetermined reference coordinates of the effector, a restriction of acceleration as seen from the predetermined reference coordinates of the effector, a restriction of angular speed as seen from the predetermined reference coordinates of the effector, a restriction of angular acceleration as seen from the predetermined reference coordinates of the effector, and a restriction of a value or a formula corresponding to an amount obtained by time-differentiating the position or the orientation three times or more.

### APPENDIX 14

A computer comprising:
a processor;
a storage unit; and
a display device configured to display a setting screen of an effector restriction which is a restriction of a change on at least one of a position or an orientation of an effector of a robot as seen from predetermined reference coordinates, wherein
the setting screen is for setting the effector restriction based at least on an input by a user, and
the processor is configured to perform a simulation that causes a model of the robot to perform the operation by using at least the effector restriction, and determine whether or not the operation satisfies a criterion.

### APPENDIX 15

The computer according to appendix 14, wherein the processor is configured to modify the effector restriction to satisfy the criterion when the operation does not satisfy the criterion.

1. A controller comprising:
a processor; and
a storage unit storing an effector restriction which is a restriction on a change in at least one of a position or an orientation of an effector of a robot as seen from predetermined reference coordinates, wherein
the processor is configured to cause the robot to execute an operation restricted by the effector restriction which is set based on an input by a user or from an external device.

2. The controller according to claim 1, wherein the storage unit is capable of storing a plurality of the effector restrictions.

3. The controller according to claim 1, wherein the storage unit is capable of storing an effector restriction set made by combining the plurality of effector restrictions.

4. The controller according to claim 3, wherein the storage unit is capable of storing a plurality of operation programs for operating the robot and the plurality of effector restriction sets respectively corresponding to the plurality of operation programs.

5. A controller comprising:
a processor;
a storage unit; and
a display device which displays a setting screen of an effector restriction which is a restriction on a change of at least one of a position or an orientation of an effector of a robot as seen from predetermined reference coordinates, wherein
the setting screen is for setting the effector restriction based at least on an input by a user.

6. The controller according to claim 1, comprising an input unit which enables input of the effector restriction.

7. The controller according to claim 1, wherein
the storage unit stores a plurality of the effector restrictions,
the plurality of effector restrictions respectively correspond to at least one of a type of the effector and a type of an object to which the effecter conduct an operation, and
the processor is configured to set the effector restrictions based at least on one of information regarding the type of the effector or information regarding the type of the object, and an input by the user.

8. The controller according to claim 7, wherein the input by the user is for setting a requirement required by the user regarding the operation by the effector.

9. The controller according to claim 1, wherein the effector restriction includes a plurality of effector restriction elements,
the effector restriction is one to which a priority can be set to at least one of the plurality of effector restriction elements, and
the processor is configured to operate the robot by using at least the effector restriction including the priority.

10. The controller according to claim 1, wherein
the effector restriction includes a plurality of effector restriction elements,
the controller is configured, for each of the plurality of effector restriction elements, to accept a setting of a designate restriction that causes the processor to use a value designated by the user or a setting of a submissive restriction that allows a change by the processor.

11. The controller according to claim 1, wherein
the processor performs a simulation that causes a model of the robot to perform the operation by using at least the effector restriction, and determine whether or not the operation satisfies a criterion.

12. The controller according to claim 11, wherein the processor is configured to modify the effector restriction to satisfy the criterion when the operation does not satisfy the criterion.

13. The controller according to claim 1, wherein the effector restriction is capable of setting at least one of a restriction of speed as seen from the predetermined reference coordinates of the effector, a restriction of acceleration as seen from the predetermined reference coordinates of the effector, a restriction of angular speed as seen from the predetermined reference coordinates of the effector, a restriction of angular acceleration as seen from the predetermined reference coordinates of the effector, and a restriction of a value or a formula corresponding to an amount obtained by time-differentiating the position or the orientation three times or more.

14. A computer comprising:
a processor;
a storage unit; and
a display device configured to display a setting screen of an effector restriction which is a restriction of a change on at least one of a position or an orientation of an effector of a robot as seen from predetermined reference coordinates, wherein
the setting screen is for setting the effector restriction based at least on an input by a user, and
the processor is configured to perform a simulation that causes a model of the robot to perform the operation by using at least the effector restriction, and determine whether or not the operation satisfies a criterion.

15. The computer according to claim 14, wherein the processor is configured to modify the effector restriction to satisfy the criterion when the operation does not satisfy the criterion.
